(19) United States
(12) Patent Application Publication
(10) Pub. No.: US 2025/0361692 A1
(43) Pub. Date: Nov. 27, 2025

(54) RAMMED SOLAR TRACKER FOUNDATIONS

(71) Applicant: Nextracker LLC, Fremont, CA (US)

(72) Inventors: Jacob Mark Morin, Phoenix, AZ (US); Abhimanyu Anil Sable, Hyderabad (IN); Michael Cook, Tulsa, OK (US); Gregory Lee White, San Jose, CA (US)

(21) Appl. No.: 19/200,171

(22) Filed: May 6, 2025

Related U.S. Application Data
(60) Provisional application No. 63/650,356, filed on May 21, 2024.
(60) Provisional application No. 63/694,968, filed on Sep. 16, 2024.

(51) Int. Cl. E02D 7/14; E02D 5/54; H02S 20/32

(52) U.S. Cl. CPC E02D 7/14; E02D 5/54; H02S 20/32; E02D 2600/40

(57) ABSTRACT

A method for installing a solar tracker A-frame foundation includes: placing a first pile at a first location along a ground surface; placing a second pile at a second location along the ground surface, the second location spaced apart from the first location; simultaneously ramming the first pile into the ground surface at the first location and ramming the second pile into the ground surface at the second location; and after simultaneously ramming the first and second piles into the ground surface, coupling a first leg of a solar tracker A-frame support to the first pile and coupling a second leg of the solar tracker A-frame support to the second pile.

### RELATED APPLICATIONS

This application claims the benefit of U.S. Provisional Patent Application No. 63/650,356, filed May 21, 2024, and U.S. Provisional Patent Application No. 63/694,968, filed Sep. 16, 2024, the entire contents of both which are incorporated herein by reference.

### TECHNICAL FIELD

This disclosure relates generally to device, system, and method embodiments for rammed solar tracker foundations and various embodiments of piles that are configured to be rammed into the ground to support a solar tracking system. Certain such embodiments disclosed herein relate to rammed solar tracker foundations, and rammable pile embodiments, for single-axis solar tracker A-frame foundations where a pair of rammable piles support a single-axis solar tracker A-frame foundation.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules.

### SUMMARY

This disclosure in general describes embodiments of devices, systems, and methods relating to solar tracker system foundations. More specifically, embodiments disclosed herein relate to device, system, and method embodiments for rammed solar tracker foundations as well as various embodiments of piles that are configured to be rammed into the ground to support a solar tracking system. Certain such embodiments disclosed herein relate to rammed solar tracker foundations, and rammable pile embodiments, for single-axis solar tracker A-frame support foundations. Such embodiments disclosed herein can be configured to provide improved efficiency associated with solar tracker system installation by providing devices, systems, and methods for rammed solar tracker piles and foundations that can reduce cost, time, and complexity associated with foundation pile installation and, thereby, help to reduce the cost associated with solar tracker system installation. In addition, these embodiments disclosed herein can also facilitate improved structural stability for solar tracking systems by providing piles for solar tracking system foundations with improved load resistance (e.g., improved lateral and/or vertical load resistance).

One embodiment includes a method for installing a solar tracker A-frame foundation. This method embodiment includes the steps of: placing a first pile at a first location along a ground surface; placing a second pile at a second location along the ground surface, the second location spaced apart from the first location; simultaneously ramming the first pile into the ground surface at the first location and ramming the second pile into the ground surface at the second location; and after simultaneously ramming the first and second piles into the ground surface, coupling a first leg of a solar tracker A-frame support to the first pile and coupling a second leg of the solar tracker A-frame support to the second pile.

In a further embodiment of this method, simultaneously ramming the first pile into the ground surface at the first location and ramming the second pile into the ground surface at the second location includes vertically driving the first pile into the ground surface at the first location without rotatably driving the first pile into the ground surface at the first location and at a same time vertically driving the second pile into the ground surface at the second location without rotatably driving the second pile into the ground surface at the second location. In one such example, vertically driving the first pile into the ground surface at the first location without rotatably driving the first pile into the ground surface at the first location can include applying vertical ramming force along or parallel to a central longitudinal axis of the first pile without applying rotational torque about the central longitudinal axis of the first pile. Similarly in this example, vertically driving the second pile into the ground surface at the second location without rotatably driving the second pile into the ground surface at the second location can include applying vertical ramming force along or parallel to a central longitudinal axis of the second pile without applying rotational torque about the central longitudinal axis of the second pile.

In an additional or alternative example, simultaneously ramming the first pile into the ground surface at the first location and ramming the second pile into the ground surface at the second location can include using a single ramming hammer to ram each of the first pile into the ground surface at the first location and the second pile into the ground surface at the second location at the same time. In one specific such embodiment, the method can additionally include: prior to simultaneously ramming the first pile and the second pile into the ground surface, placing a ramming adapter at the first pile, at the second pile, and across the first pile and the second pile. For instance, using the single ramming hammer to ram each of the first pile into the ground surface at the first location and the second pile into the ground surface at the second location at the same time can include ramming the single ramming hammer into direct contact with the ramming adapter to simultaneously: (i) vertically drive the first pile into the ground surface at the first location without rotatably driving the first pile into the ground surface at the first location, and (ii) vertically drive the second pile into the ground surface at the second location without rotatably driving the second pile into the ground surface at the second location. In some instances, this can additionally include, after using the single ramming hammer to ram each of the first pile into the ground surface at the first location and the second pile into the ground surface at the second location at the same time and prior to coupling the first leg of the solar tracker A-frame support to the first pile and the second leg of the solar tracker A-frame support to the second pile, removing the ramming adapter from each of the first pile and the second pile.

Various ramming adapter configurations can be used. As one example, the ramming adapter can include a first adapter pile connector at a first side of the ramming adapter, a second adapter pile connector at a second, opposite side of the ramming adapter, and a hammer contact interface located at the ramming adapter between the first adapter pile connector and the second adapter pile connector. For this example, placing the ramming adapter at the first pile, at the second pile, and across the first pile and the second pile can include placing the first adapter pile connector at the first pile and placing the second adapter pile connector at the second pile such that the hammer contact interface is between the first pile and the second pile. Then, using the single ramming hammer to ram each of the first pile into the ground surface at the first location and the second pile into the ground surface at the second location at the same time can include ramming the single ramming hammer into direct contact with the hammer contact interface between the first pile and the second pile.

In a further embodiment of this method, the first pile can include a first pile body that includes a first pile outer perimeter surface that encloses a hollow interior at the first pile body. Similarly, the second pile can include a second pile body that includes a second pile outer perimeter surface that encloses a hollow interior at the second pile body. As one example, the first pile body can further include: (i) at least one first pile wing projecting outward from the first pile outer perimeter surface in a direction perpendicular to a central longitudinal axis of the first pile, and (ii) a pointed first pile distal end that is configured to vertically drive into the ground surface. And similarly, the second pile body can further include: (i) at least one second pile wing projecting outward from the second pile outer perimeter surface in a direction perpendicular to a central longitudinal axis of the second pile, and (ii) a pointed second pile distal end that is configured to vertically drive into the ground surface. As another additional or alternative example, the first pile body can include two or more first pile blades, where each of the two or more first pile blades: project outward from the first pile outer perimeter surface in a direction perpendicular to a central longitudinal axis of the first pile and extend, at a skewed orientation relative to the central longitudinal axis of the first pile, both a distance longitudinally along the first pile outer perimeter surface and a distance radially along the first pile outer perimeter surface. And similarly, the second pile body can include two or more second pile blades, where each of the two or more second pile blades: project outward from the second pile outer perimeter surface in a direction perpendicular to a central longitudinal axis of the second pile and extend, at a skewed orientation relative to the central longitudinal axis of the second pile, both a distance longitudinally along the second pile outer perimeter surface and a distance radially along the second pile outer perimeter surface. For some such examples, each of the two or more first pile blades is rotatably coupled to the first pile outer perimeter surface, and each of the two or more second pile blades is rotatably coupled to the second pile outer perimeter surface.

In a further embodiment of this method, the first pile includes a first pile body that includes a first pile outer perimeter surface that encloses a hollow interior at the first pile body. The first pile body has a proximal first pile end portion and a distal first pile end portion. The first pile further includes a first pile ramming drive shaft that includes a proximal first pile ramming drive shaft end portion and a distal first pile ramming drive shaft end portion. The distal first pile ramming drive shaft end portion is coupled to the distal first pile end portion, and the proximal first pile ramming drive shaft end portion extends out from the proximal first pile end portion such that the proximal first pile ramming drive shaft end portion is exposed outside of the hollow interior at the first pile body. Similarly, the second pile includes a second pile body that includes a second pile outer perimeter surface that encloses a hollow interior at the second pile body. The second pile body has a proximal second pile end portion and a distal second pile end portion. The second pile further includes a second pile ramming drive shaft that includes a proximal second pile ramming drive shaft end portion and a distal second pile ramming drive shaft end portion. The distal second pile ramming drive shaft end portion is coupled to the distal second pile end portion, and the proximal second pile ramming drive shaft end portion extends out from the proximal second pile end portion such that the proximal second pile ramming drive shaft end portion is exposed outside of the hollow interior at the second pile body. In one such example, simultaneously ramming the first pile into the ground surface at the first location and ramming the second pile into the ground surface at the second location includes simultaneously ramming the first pile at the exposed proximal first pile ramming drive shaft end portion and ramming the second pile at the exposed proximal second pile ramming drive shaft end portion. And, in a further such example, the method can additionally include: after simultaneously ramming the first and second piles into the ground surface and prior to coupling the first leg of a solar tracker A-frame support to the first pile and coupling the second leg of the solar tracker A-frame support to the second pile, removing the exposed proximal first pile ramming drive shaft end portion from the first pile ramming drive shaft and removing the exposed proximal second pile ramming drive shaft end portion from the second pile ramming drive shaft.

In a further embodiment of this method, the first pile includes a first pile body that includes a first pile outer perimeter surface that encloses a hollow interior at the first pile body. The first pile body has a proximal first pile end portion and a distal first pile end portion. The first pile further includes at least two first pile stabilizing fingers. Each of the at least two first pile stabilizing fingers is configured, as a result of ramming the first pile into the ground surface at the first location, to move from a stowed configuration at the first pile outer perimeter surface and generally parallel to a central longitudinal axis of the first pile to a deployed configuration extending out from the first pile outer perimeter surface at a skewed or perpendicular orientation relative to the central longitudinal axis of the first pile. Similarly, the second pile includes a second pile body that includes a second pile outer perimeter surface that encloses a hollow interior at the second pile body. The second pile body has a proximal second pile end portion and a distal second pile end portion. The second pile further includes at least two second pile stabilizing fingers. Each of the at least two second pile stabilizing fingers is configured, as a result of ramming the second pile into the ground surface at the second location, to move from a stowed configuration at the second pile outer perimeter surface and generally parallel to a central longitudinal axis of the second pile to a deployed configuration extending out from the second pile outer perimeter surface at a skewed or perpendicular orientation relative to the central longitudinal axis of the second pile.

One rammable solar tracker foundation pile embodiment includes a pile body and a pile ramming drive shaft. The pile body includes a pile outer perimeter surface that encloses a hollow interior at the pile body. The pile body further includes a proximal pile end portion and a distal pile end portion. The pile ramming drive shaft includes a proximal pile ramming drive shaft end portion, a distal pile ramming drive shaft end portion, and a pile ramming drive shaft body extending between the proximal pile ramming drive shaft end portion and the distal pile ramming drive shaft end portion. The pile ramming drive shaft body is located within the hollow interior of the pile body. The distal pile ramming drive shaft end portion is coupled to the distal pile end portion. The proximal pile ramming drive shaft end portion is uncoupled from the proximal pile end portion and extends out from the proximal pile end portion such that the proximal pile ramming drive shaft end portion is exposed outside of the hollow interior at the pile body.

In a further embodiment of this pile, the pile ramming drive shaft body is located within the hollow interior of the pile body and is uncoupled from the pile body (e.g., the pile ramming drive shaft body is uncoupled from the hollow interior of the pile body) such that the pile ramming drive shaft is only coupled to the pile body where the distal pile ramming drive shaft end portion is coupled to the distal pile end portion. And the proximal pile ramming drive shaft end portion is deformable and configured to be removed from the pile ramming drive shaft after applying vertical ramming force at the proximal pile ramming drive shaft end portion.

Another rammable solar tracker foundation pile embodiment includes a pile body and at least two pile stabilizing fingers at the pile body. The pile body includes a pile outer perimeter surface that encloses a hollow interior at the pile body. The pile body further includes a proximal pile end portion and a distal pile end portion. Each of the at least two pile stabilizing fingers at the pile body is configured, as a result of ramming the pile body into a ground surface, to move from a stowed configuration at the pile outer perimeter surface and generally parallel to a central longitudinal axis of the pile body to a deployed configuration at which each of the at least two pile stabilizing fingers extends out from the pile outer perimeter surface at a skewed or perpendicular orientation relative to the central longitudinal axis of the pile body.

In a further embodiment of this pile, each of the at least two pile stabilizing fingers is located at the distal pile end portion outside of the hollow interior at each of the stowed and deployed configurations. And the pile body includes a slit separating a first longitudinal side of a first pile stabilizing finger of the at least two pile stabilizing fingers from a second longitudinal side of a second pile stabilizing finger of the at least two pile stabilizing fingers.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a side elevational view of an embodiment of solar tracking system that includes a plurality of A-frame foundations each having pairs of piles supporting an A-frame support. FIG. 1 shows the side elevational view looking in an east-west orientation.

FIGS. 2A-2D illustrate a sequence, at a common side elevational view, for installing an A-frame foundation by simultaneously ramming a pair of piles. FIG. 2A shows a first phase of the sequence where first and second piles are placed at respective locations along a ground surface. FIG. 2B shows another (e.g., second) phase of the sequence where a ramming hammer is placed relative to the first and/or second piles. FIG. 2C shows another (e.g., third) phase of the sequence where the ramming hammer is used to simultaneously ram the first and second piles into the ground surface. And FIG. 2D shows another (e.g., fourth) phase of the sequence, after simultaneously ramming the first and second piles into the ground surface at FIG. 2C, where a first leg of a solar tracker A-frame support is coupled to the first pile and a second leg of the solar tracker A-frame support is coupled to the second pile.

FIGS. 3A-3E illustrate one embodiment of a rammable solar tracker foundation pile. FIG. 3A is a side elevational view of this embodiment of the rammable solar tracker foundation pile, FIG. 3B is a top plan view of this embodiment of the rammable solar tracker foundation pile, and FIGS. 3C-3E illustrate side elevational view examples of distal ends of this rammable solar tracker foundation pile, for instance, to vertically drive into the rammable solar tracker foundation pile into the ground surface.

FIGS. 4A and 4B illustrate another embodiment of a rammable solar tracker foundation pile that includes a pile ramming drive shaft for ramming the pile into the ground surface. FIG. 4A is a side elevational view of this rammable solar tracker foundation pile placed at the ground surface, and FIG. 4B is a side elevational view of this rammable solar tracker foundation pile being rammed into the ground surface using the pile ramming drive shaft.

FIGS. 5A-5C illustrate another embodiment of a rammable solar tracker foundation pile that includes pile blades. FIG. 5A is a side elevational view of this rammable solar tracker foundation pile with pile blades at a first side, FIG. 5B is another side elevational view of this rammable solar tracker foundation pile with pile blades at a second side spaced ninety degrees from the first side at FIG. 5A, and FIG. 5C is a top plan view of view of this rammable solar tracker foundation pile with pile blades.

FIGS. 6A and 6B illustrate another embodiment of a rammable solar tracker foundation pile that includes pile stabilizing fingers. FIG. 6A is a side elevational view of this rammable solar tracker foundation pile with the pile stabilizing fingers at a stowed configuration, and FIG. 6B is a side elevational view of this rammable solar tracker foundation pile with the pile stabilizing fingers at a deployed configuration.

FIG. 7 is a flow diagram of an embodiment of a method for installing a solar tracker A-frame foundation using rammed A-frame piles to support an A-frame support.

FIGS. 8A-8C illustrate another embodiment of a rammable solar tracker foundation pile that includes an I-beam cross-section. FIG. 8A is a side elevational view of the I-beam rammable solar tracker foundation pile being rammed into the ground surface, FIG. 8B is a plan view of the I-beam cross-section of FIG. 8A, and FIG. 8C is a perspective view showing a frame coupling adapter coupled to the I-beam rammable solar tracker foundation pile (e.g., after it has been embedded in the ground).

FIGS. 9A-9F illustrate another embodiment of a rammable solar tracker foundation pile that includes cross blades. FIG. 9A is schematic diagram showing a pair of cross blade solar tracker foundation piles embedded in the ground and supporting an above ground A-frame, and FIG. 9B is a perspective view of one exemplary embodiment of cross blades at the solar tracker foundation pile. FIGS. 9C-9F illustrate elevational views of various embodiments of a pair of cross blade solar tracker foundation piles embedded in the ground and supporting an above ground A-frame.

FIGS. 10A and 10B illustrate yet another embodiment of a rammable solar tracker foundation pile that includes a bolted cross blade. FIG. 10A is an exploded, assembly view of this rammable solar tracker foundation pile, and FIG. 10B is an elevational view of the assembled rammable solar tracker foundation pile with bolted cross blade.

FIG. 11 is an elevational view of another embodiment of a rammable solar tracker foundation pile that includes a plurality of embedment projections.

FIGS. 12A-12E illustrate another embodiment of a rammable solar tracker foundation pile that includes at least one rotatable bearing flange. FIG. 12A is a perspective view of this rammable solar tracker foundation pile. FIGS. 12B and 12C show rotatable bearing flanges of the rammable solar tracker foundation pile each at a flange installation orientation, with FIG. 12B showing a side elevational view and FIG. 12C showing a top plan view. FIGS. 12D and 12E show rotatable bearing flanges of the rammable solar tracker foundation pile each at a flange pull out resistance orientation.

FIGS. 13A and 13B illustrate yet another embodiment of a rammable solar tracker foundation pile that includes at least one bearing pin. FIG. 13A is an exploded, assembly view of this rammable solar tracker foundation pile, and FIG. 13B is a perspective view of the assembled rammable solar tracker foundation pile with at least one bearing pin.

FIGS. 14A and 14B illustrate another embodiment of a rammable solar tracker foundation pile that includes a bearing beam adapter. FIG. 14A is an exploded, assembly view of this rammable solar tracker foundation pile, and FIG. 14B is a perspective view of the assembled rammable solar tracker foundation pile with bearing beam adapter.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include devices, systems, and methods for rammed solar tracker foundations and various embodiments of piles that are configured to be rammed into the ground to support a solar tracking system. Certain such embodiments disclosed herein relate to rammed solar tracker foundations, and rammable pile embodiments, for single-axis solar tracker A-frame foundations where a pair of rammable piles support a single-axis solar tracker A-frame foundation. Though other embodiments within the scope of this disclosure can utilize the disclosed devices, systems, and methods for other types of foundations in other applications.

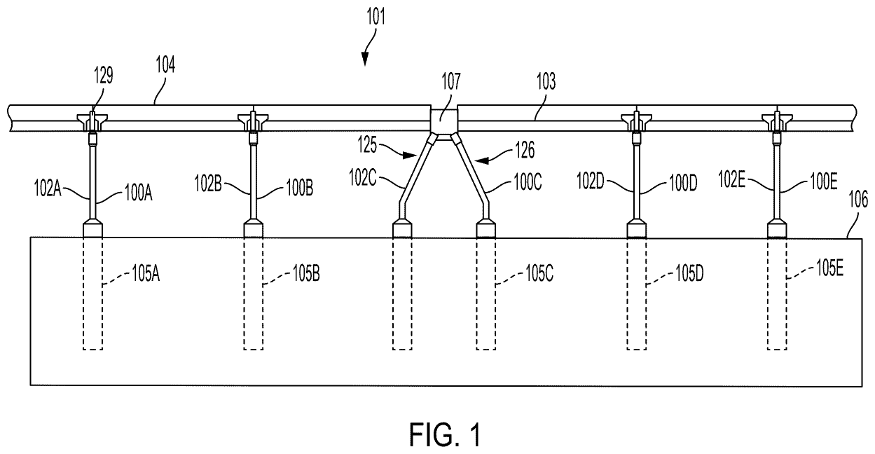

FIG. 1 is a side elevational view of an embodiment of solar tracking system 101. The solar tracking system 101 includes a plurality of solar tracker A-frame foundations 102A, 102B, 102C, 102D, 102E that support a torque tube 103 and a plurality of solar modules 104 via the torque tube 103. Each solar tracker A-frame foundation 102A, 102B, 102C, 102D, 102E can include a respective pair of piles 105A, 105B, 105C, 105D, 105E that supports a respective A-frame support 100A, 100B, 100C, 100D, 100E. Each pair of piles 105A-105E can be embedded into a ground surface 106 and, thereby, act to anchor the respective A-frame support 100A-100E at the ground surface 106. FIG. 1 shows the solar tracking system side elevational view looking in an east-west orientation at A-frame supports 100A-100E and associated, respective pairs of piles 105A-105E. As shown for the illustrated example at FIG. 1, A-frame supports 100A, 100B, 100D, and 100E can be oriented in one direction, while the A-frame support 100C can be oriented in a different direction, such as generally ninety degrees offset from the A-frame supports 100A, 100B, 100D, 100E. For instance, the A-frame supports 100A, 100B, 100D, 100E can face one of east-west and north-south while the A-frame support 100C can face the other of east-west and north-south. With these different orientations of the A-frame foundations 102A, 102B, 102D, 102E versus A-frame foundation 102C, the illustrated example at FIG. 1 shows the pair of piles 105C supporting the A-frame support 102C while only one pile of the pair of piles 105A, 105B, 105D, 105E is visible in FIG. 1 supporting the A-frame supports 102A, 102B, 102D, 102E.

The system 101 that includes the respective pairs of piles 105A-105E supporting the respective A-frame supports 100A-100E can be used to support a plurality of solar modules 104 and to change the orientation of the plurality of solar modules 104 to track the position of the sun throughout the day by rotating the torque tube 103. For example, the system 101 can include a motive source 107 (e.g., powered drive motor), and the motive source 107 can be coupled to the torque tube 103 to apply a rotational (e.g., torque) force on the torque tube 103 to cause the torque tube 103 to rotate about a single longitudinal axis. The system 101 can also include one or more bearing housing assemblies 129 that receive the torque tube 103 and rotatably support the torque tube 103 as it is rotated by the motive source 107. The motive source 107 and bearing housing assemblies 129 can be mounted to the A-frame foundations 102A, 102B, 102D, 102E, such as shown at the example of FIG. 1. As the torque tube 103 is so rotated by the system 101, the plurality of solar modules 104 also rotate with the torque tube 103 to track the position of the sun as it changes throughout a given day. Each of the plurality of solar modules 104 can include a plurality of photovoltaic cells that are configured to receive sunlight and as a result generate electrical energy. The torque tube 103 can be rotatably actuated by a controller, for instance associated with the motive source 107, to cause the torque tube 103 to rotate about a rotational axis of the system 101.

The A-frame supports 100A-100E and respective, associated pairs of piles 105A-105E that form solar tracker A-frame foundations 102A-102E used to support the plurality of rotatable solar modules 104 can experience a variety of force loads. For example, the A-frame supports 100A-100E and respective, associated pairs of piles 105A-105E can experience dynamic loads in the field from natural forces, such as wind loads. As another example, the A-frame supports 100A-100E and respective, associated pairs of piles 105A-105E can experience dynamic loads in the field resulting from operation of the solar module tracking system, such as loads on the A-frame supports 100A-100E and respective, associated pairs of piles 105A-105E resulting from movement (e.g., rotation) of the torque tube 103. In some instances, these loads can occur at a same time, resulting in meaningful force loading at the A-frame supports 100A-100E. Accordingly, it can be useful to accommodate such loads experienced at the A-frame supports 100A-100E using a structurally robust foundation. Yet, depending on the length of the tracker row, a solar tracking system can include hundreds of A-frame supports 100A-100E each needing a dedicated pair of piles 105A-105E to support and anchor the A-frame supports 100A-100E at the ground surface 106 and, as such, installation efficiency of the significant number of the pairs of piles 105A-105E can be useful in significantly reducing the costs associated with solar tracker system installation.

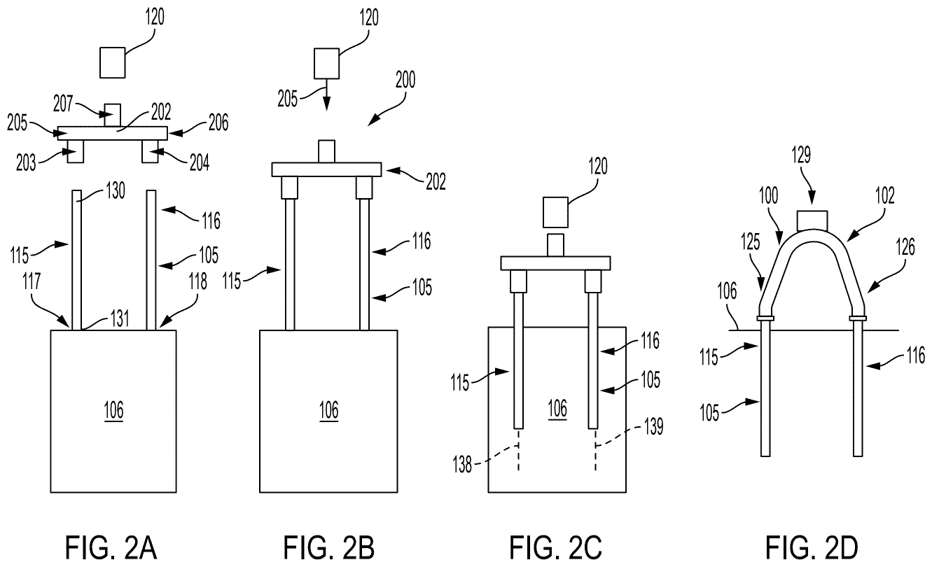

FIGS. 2A-2D illustrate a sequence, at a common side elevational view, for installing an A-frame foundation 102 by simultaneously ramming a pair of piles 105. FIG. 2A shows a first phase of the sequence where a pair of piles 105 includes a first pile 115 and a second pile 116 that are, respectively, placed at first and second locations 117, 118 along ground surface 106. FIG. 2B shows another (e.g., second) phase of the sequence where a ramming hammer 120 is placed relative to the first and/or second piles 115, 116. FIG. 2C shows another (e.g., third) phase of the sequence where the ramming hammer 120 is used to simultaneously ram the first and second piles 115, 116 into the ground surface 106. And FIG. 2D shows another (e.g., fourth) phase of the sequence, after simultaneously ramming the first and second piles 115, 116 into the ground surface 106 at FIG. 2C, where a first leg 125 of solar tracker A-frame support 100 is coupled to the first pile 115 and a second leg 126 of the solar tracker A-frame support 100 is coupled to the second pile 116.

At FIG. 2A of the sequence, as noted, the pair of piles 105 includes the first pile 115 and the second pile 116. At FIG. 2A, the first pile 115 is placed at a first location 117 along the ground surface 106 and the second pile 116 is placed at a second location 118 along ground surface 106, where the second location 118 is spaced apart from the first location 117. For instance, each pile 115, 116 can include a pile proximal end portion 130 and an opposite pile distal end portion 131, and the pile distal end portion 131 can be placed into contact with ground surface 106 with pile proximal end portion 130 being opposite ground surface 106. As will be described in reference to the exemplary sequence shown, the first and second piles 115, 116 can be rammed into the ground surface 106 at the respective first and second locations 117, 118 and then have A-frame support 100 coupled to the first and second rammed piles 115, 116.

At FIG. 2B, the first pile 115 is rammed into the ground surface 106 and the second pile 116 is rammed into the ground surface 106. As one example illustrated here, the first pile 115 can be rammed into the ground surface 106 at the first location 117 simultaneous to ramming the second pile 116 into the ground surface 106 at the second location 118.

To simultaneously ram the first and second piles 115, 116 into the ground surface 106 at the respective first and second locations 117, 118, a simultaneous ramming system 200 can be used. The simultaneous ramming system 200 can include the ramming hammer 120 and a ramming adapter 202. For instance, as shown at FIG. 2B, prior to simultaneously ramming the first pile 115 and the second pile 116 into the ground surface 106, the ramming adapter 202 can be placed at the first pile 115, at the second pile 116, and across the first pile and the second pile. Then, with the ramming adapter 202 so placed, single ramming hammer 120 can be used (e.g., as shown at FIG. 2C) to ram each of the first pile 115 into the ground surface 106 at the first location 117 and the second pile 116 into the ground surface 106 at the second location 118 at the same time. This can include ramming the single ramming hammer 120 into direct contact with the ramming adapter 202 to simultaneously vertically drive the first pile 115 into the ground surface 106 at the first location 117 and vertically drive the second pile 116 into the ground surface 106 at the second location 118.

Thus, the ramming adapter 202 can act to bridge between the pair of piles 115, 116 to thereby enable a single ramming hammer 120 to simultaneously vertically drive both of the pair of piles 115, 116 into the ground surface 106. The configuration of the ramming adapter 202 to do so can vary depending on the particular application. The illustrated, exemplary embodiment of the ramming adapter 202 shown here includes a first adapter pile connector 203 at a first side 205 of the ramming adapter 202, a second adapter pile connector 204 at a second, opposite side 206 of the ramming adapter 202, and a hammer contact interface 207 located at the ramming adapter 202 between the first adapter pile connector 203 and the second adapter pile connector 204. For this configuration, placing the ramming adapter 202 at the first pile 115, at the second pile 116, and across the first and second piles 115, 116 can include placing the first adapter pile connector 203 at the first pile 115 (e.g., at the first pile proximal end portion 130) and placing the second adapter pile connector 204 at the second pile 116 (e.g., at the second pile proximal end portion 130) such that the hammer contact interface 207 is between the first pile 115 and the second pile 116. Then, using the single ramming hammer 120 to ram each of the first pile 115 into the ground surface 106 at the first location 117 and the second pile 116 into the ground surface 106 at the second location 118 at the same time can include ramming the single ramming hammer 120, in direction 205, into direct contact with the hammer contact interface 207 between the first pile 115 and the second pile 116.

FIG. 2C shows use of the simultaneous ramming system 200 to simultaneously ram the first pile 115 into the ground surface 106 at the first location 117 and the second pile 116 into the ground surface 106 at the second location 118. Simultaneously ramming the first and second piles 115, 116 into the ground surface 106 at the respective first and second locations 117, 118 can include vertically driving the first pile 115 into the ground surface 106 at the first location 117 without rotatably driving the first pile 115 into the ground surface 106 at the first location 117 and at a same time vertically driving the second pile 116 into the ground surface 106 at the second location 118 without rotatably driving the second pile 116 into the ground surface 106 at the second location 118. For instance, vertically driving the first pile 115 into the ground surface 106 at the first location 117 without rotatably driving the first pile 115 into the ground surface 106 at the first location 117 can include applying vertical ramming force (e.g., in the direction 205 via hammer 120) along or parallel to a central longitudinal axis 138 of the first pile 115 without applying rotational torque about the central longitudinal axis 138 of the first pile 115. And vertically driving the second pile 116 into the ground surface 106 at the second location 118 without rotatably driving the second pile 116 into the ground surface 106 at the second location 118 can simultaneously include applying vertical ramming force (e.g., in the direction 205 via hammer 120) along or parallel to a central longitudinal axis 139 of the second pile 116 without applying rotational torque about the central longitudinal axis 139 of the second pile 116.

As illustrated for the example embodiment shown here, simultaneously ramming the first pile 115 into the ground surface 106 at the first location 117 and ramming the second pile 116 into the ground surface 106 at the second location 118 can include using a single ramming hammer 120 to ram each of the first pile 115 and the second pile 116 into the ground surface 106 at different locations along the ground surface 106, which can be useful in increasing installation efficiency. More particularly, for the illustrated embodiment, using single ramming hammer 120 to ram each of the first pile 115 and the second pile 116 into different locations 117, 118 along the ground surface 106 at the same time can include ramming the single ramming hammer 102 into direct contact with the ramming adapter 202 (e.g., ramming the single ramming hammer 102 into direct contact with the hammer contact interface 207) to simultaneously: (i) vertically drive the first pile 115 into the ground surface 106 at the first location 117 without rotatably driving the first pile 115 into the ground surface 106 at the first location 117, and (ii) vertically drive the second pile 116 into the ground surface 106 at the second location 118 without rotatably driving the second pile 116 into the ground surface 106 at the second location 118.

After ramming (e.g., simultaneously ramming) the first and second piles 115, 116 a desired distance into the ground surface 106, as shown at FIG. 2D, the solar tracker A-frame support 100 can be coupled to the rammed, ground embedded first and second piles 115, 116. For example, after simultaneously ramming the first and second piles 115, 116 into the ground surface 106, first leg 125 of solar tracker A-frame support 100 can be coupled to the first rammed, embedded pile 115 and coupling second leg 126 of solar tracker A-frame support 100 to the second rammed, embedded pile 116. For instance, after using the single ramming hammer 120 to simultaneously ram each of the first and second piles 115, 116 into the ground surface 106 at FIG. 2C and prior to coupling the first and second legs 125, 126 of the solar tracker A-frame support 100 to the first and second embedded piles 115, 116 at FIG. 2D, the ramming adapter 202 can be removed from each of the first and second piles 115. Removing the ramming adapter 202 can reveal the pile proximal end portion 130 at each of the first and second embedded piles 115, 116, and the first leg 125 of the solar tracker A-frame support 100 can be secured to above-ground pile proximal end portion 130 at first pile 115 and the second leg 126 of the solar tracker A-frame support 100 can be secured to above-ground pile proximal end portion 130 at second pile 116.

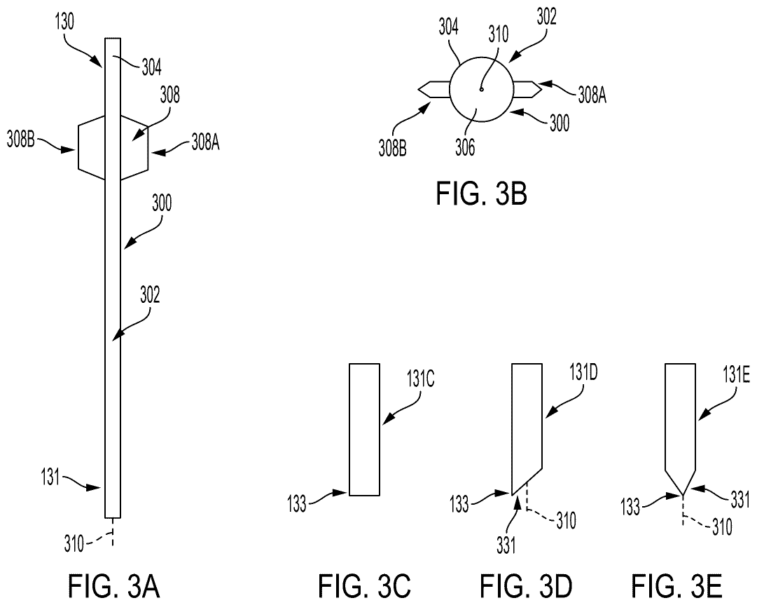

FIGS. 3-6 illustrate exemplary embodiments of piles and pile features that can be used for one or both of the pair of rammable piles in the sequence shown and described at FIGS. 2A-2D.

FIGS. 3A-3E illustrate one embodiment of a rammable solar tracker foundation pile 300. As noted, the pile 300 can be used as the first and/or second pile in the sequence disclosed at FIG. 2 (e.g., pile 300 can be the first pile 115 and the second pile 116 in the sequence at FIG. 2). FIG. 3A is a side elevational view of the rammable solar tracker foundation pile 300, FIG. 3B is a top plan view of the rammable solar tracker foundation pile 300, and FIGS. 3C-3E illustrate side elevational view examples of pile distal end portions 131 of the rammable solar tracker foundation pile 300, for instance, to vertically drive into the rammable solar tracker foundation pile 300 into the ground surface 106.

The pile 300 includes a pile body 302. The pile body 302 includes a pile outer perimeter surface 304 that encloses a hollow interior 306 at the pile body 302. The pile body 302 illustrated here can have a closed pile outer perimeter surface 304 that fully encloses the hollow interior 306. For example, as shown at FIG. 3B, the pile body 302 can have a cylindrical cross-sectional geometry that defines a closed pile outer perimeter surface 304 that fully encloses the hollow interior 306. In other embodiments within the scope of this disclosure, the pile body 302 can have other cross-sectional geometries, for instance polygonal cross-sectional geometries, that define closed pile outer perimeter surface 304 that fully encloses hollow interior 306. Pile body 302 having a closed pile outer perimeter surface 304 that fully encloses the hollow interior 306 can be useful in leveraging the increased load-bearing capacity and structural integrity of a pile body closed outer perimeter surface when embedded within the ground surface.

As shown at the examples of FIGS. 3A and 3B, the pile body 302 can further include at least one pile wing 308. The at least one pile wing 308 can project outward from the pile outer perimeter surface 304 in a direction perpendicular to a central longitudinal axis 310 of the pile 300. The illustrated embodiment of the pile 300 includes two pile wings 308A, 308B each extending outward from the pile outer perimeter surface 304 in the direction perpendicular to the central longitudinal axis 310. Pile wing 308A is generally at an opposite side of the pile outer perimeter surface 304 from the pile wing 308B. Pile wings 308A, 308B can be located along a length of the pile body 302 closer to pile proximal end portion 130 than to pile distal end portion 131. In some examples, pile wings 308A, 308B can be located at or adjacent to the pile proximal end portion 130, for instance, at a location along the length of the pile body 302 so as to be embedded within the ground surface 106. The inclusion of one or more such pile wing(s) 308 can help to increase the lateral load resistance of the pile when embedded within the ground surface.

As shown at FIGS. 3C-3E, the pile 300 can include pile distal end portion 131 that that is configured to vertically drive into the ground surface when the pile 300 is rammed. Namely, the pile distal end portion 131 can be configured to penetrate, and be vertically driven into, ground surface when rammed (e.g., when rammed at the opposite pile proximal end portion 130).

FIG. 3C shows one such example pile distal end portion 131C. Here, an entire perimeter surface of a distal end 133 at the pile distal end portion 131C lies in a common plane. For example, the distal end 133 at the pile distal end portion 131C can be a cylindrical cross-sectional geometry that defines closed pile outer perimeter surface 304 that fully encloses hollow interior 306 at the distal end 133. In other example, the distal end 133 at the pile distal end portion 131C can be any polygonal cross-sectional geometry that defines closed pile outer perimeter surface 304 that fully encloses hollow interior 306 at the distal end 133.

FIG. 3D shows another example pile distal end portion 131D. Here, pile distal end portion 131D includes a pointed pile distal end 331. Thus, portions of the perimeter surface of the distal end 133 at the pile distal end portion 131D lay in different elevational planes moving around the perimeter surface of the distal end 133 at the pile distal end portion 131D. Here the pointed pile distal end 331 is at one side of the distal end 133 and forms the distal-most perimeter surface portion at pile distal end portion 131D.

FIG. 3E shows yet another example pile distal end portion 131E. Here, pile distal end portion 131E includes pointed pile distal end 331. Thus, portions of the perimeter surface of the distal end 133 at the pile distal end portion 131E lay in different elevational planes moving around the perimeter surface of the distal end 133 at the pile distal end portion 131E. Here the pointed pile distal end 331 is formed centrally on the central longitudinal axis 310 at the distal end 133 and forms the distal-most perimeter surface portion at pile distal end portion 131E.

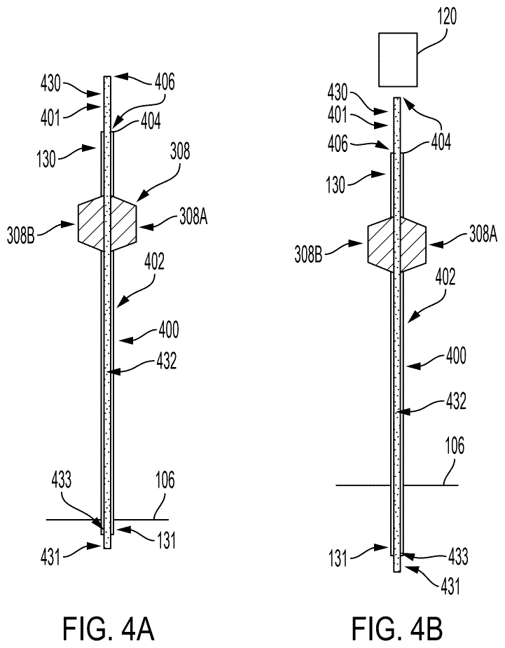

FIGS. 4A and 4B illustrate another embodiment of a rammable solar tracker foundation pile 400 that includes a pile ramming drive shaft 401 for ramming the pile 400 into the ground surface 106. As noted, the pile 400 can be used as the first and/or second pile in the sequence disclosed at FIG. 2 (e.g., pile 400 can be the first pile 115 and the second pile 116 in the sequence at FIG. 2). FIG. 4A shows a side elevational view of the rammable solar tracker foundation pile 400 placed at the ground surface 106, and FIG. 4B is a side elevational view of the rammable solar tracker foundation pile 400 being rammed into the ground surface 106 using the pile ramming drive shaft 401.

In addition to the pile ramming drive shaft 401, the pile 400 can include pile body 402. The pile body 402 can include pile outer perimeter surface 404 that encloses a hollow interior 406 at the pile body 402. The pile body 402 can have proximal pile end portion 130 and opposite distal pile end portion 131. The pile ramming drive shaft 401 can include a proximal pile ramming drive shaft end portion 430, a distal pile ramming drive shaft end portion 431, and a pile ramming drive shaft body 432 extending between the proximal pile ramming drive shaft end portion 430 and the distal pile ramming drive shaft end portion 431. The pile ramming drive shaft body 432 can be located within the hollow interior 406 of the pile body 402.

The distal pile ramming drive shaft end portion 431 can be coupled to the distal pile end portion 131 at coupling 433, but the proximal pile ramming drive shaft end portion 430 can be uncoupled from the proximal pile end portion 130 and the proximal pile ramming drive shaft end portion 430 can extend out from the proximal pile end portion 130 such that the proximal pile ramming drive shaft end portion 430 is exposed outside of the hollow interior 406 at the pile body 402. Similar to the proximal pile ramming drive shaft end portion 430, the pile ramming drive shaft body 432 can be located within the hollow interior 406 of the pile body 402 and uncoupled therein from the pile body 402 such that the pile ramming drive shaft 401 in this embodiment is only coupled to the pile body 402 where the distal pile ramming drive shaft end portion 431 is coupled to the distal pile end portion 131 (e.g., pile ramming drive shaft body 432 within hollow interior 406 is uncoupled from pile body 402). Notably, this configuration of the pile ramming drive shaft 401 being coupled to the pile 400 at only the coupling 433 between the distal pile ramming drive shaft end portion 431 and the distal pile end portion 131 can act to transfer vertical ramming force from the hammer 120 to the pile body 402 via the coupling 433 between the distal pile ramming drive shaft end portion 431 and the distal pile end portion 131 at the distal portion of the pile body 402. This can be useful in mitigating compressive load-induced deformation (e.g., from hammer 120) at pile proximal end portion 130 of the pile body 402 to thereby help preserve the structure of the pile proximal end portion 130 for coupling to an A-frame support after ramming.

Pile 400 can be used as first and second piles that are simultaneously rammed into ground surface 106 at spaced apart locations along the ground surface 106. This can be done by simultaneously ramming each of the pair of piles 400 into the ground surface 106 at respective first and second locations by ramming a first pile 400 at the exposed proximal first pile ramming drive shaft end portion 430 and ramming a second pile 400 at the exposed proximal second pile ramming drive shaft end portion 430. This can include simultaneously ramming each of the exposed proximal first pile ramming drive shaft end portion 430 and the exposed proximal second pile ramming drive shaft end portion 430 using the single hammer 120 and the ramming adapter. In some examples, the proximal pile ramming drive shaft end portion 430 can be configured to be deformable, for instance, when ramming the exposed proximal pile ramming drive shaft end portion 430 (e.g., upon application of vertical ramming force). In certain such examples, the proximal pile ramming drive shaft end portion 430 can be further configured to be removed from the pile ramming drive shaft 401 after applying vertical ramming force at (e.g., and deforming) the proximal pile ramming drive shaft end portion 430. Thus, in such examples, after simultaneously ramming the first and second piles 400 into the ground surface 106 and prior to coupling the legs of the solar tracker A-frame support to such first and second piles 400, the exposed proximal first pile ramming drive shaft end portion 430 can be removed from each of the first and second pile ramming drive shaft 401. Removing the deformed exposed proximal first pile ramming drive shaft end portion 430 after ramming the pile body 402 into the ground surface using the ramming drive shaft 401 as the interface for receiving the vertical ramming force can leave A-frame leg coupling at pile body 402 as an exposed receptacle for coupling to a leg of the A-frame support.

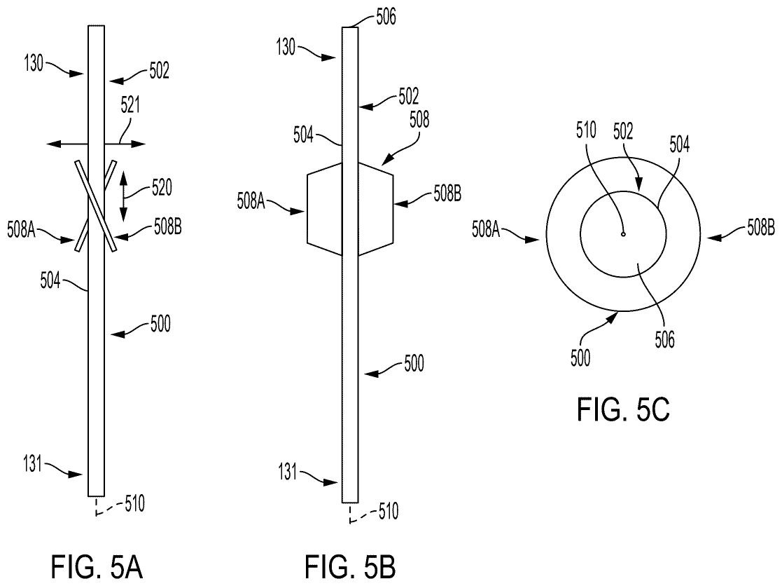

FIGS. 5A-5C illustrate another embodiment of a rammable solar tracker foundation pile 500 that includes at least one pile blade 508. As noted, the pile 500 can be used as the first and/or second pile in the sequence disclosed at FIG. 2 (e.g., pile 500 can be the first pile 115 and the second pile 116 in the sequence at FIG. 2). FIG. 5A shows a first side elevational view of this rammable solar tracker foundation pile 500 with pile blades 508, FIG. 5B shows a second side elevational view, spaced ninety degrees from the first side shown at FIG. 5A, of the rammable solar tracker foundation pile 500 with pile blades 508, and FIG. 5C is a top plan view of view of the rammable solar tracker foundation pile 500 with pile blades 508.

The rammable solar tracker foundation pile 500 can include a pile body 502. The pile body 502 can include two or more pile blades 508A, 508B. Each of the two or more pile blades 508A, 508B can project outward from the pile outer perimeter surface 504 in a direction perpendicular to a central longitudinal axis 510 of the pile 500. In addition, each of the two or more pile blades 508A, 508B can extend, at a skewed orientation relative to the central longitudinal axis 510, both a distance 520 longitudinally along the pile outer perimeter surface 504 and a distance 521 radially along the pile outer perimeter surface 504. For example, each of the pile blades 508A, 508B can define a pitch wrapping radially around a portion of the pile outer perimeter surface 504 while extending longitudinally along the pile outer perimeter surface 504. For instance, the pile blades 508A, 508B can resemble turbine-shaped blades contoured in both radial and longitudinal directions around at least a portion of the pile outer perimeter surface 504.

In one particular such example, one or more such pile blades 508A, 508B can be rotatably coupled to the pile 500. For example, each pile blade 508A, 508B can be rotatably coupled to the pile outer perimeter surface 504 such that the pile blades 508A, 508B are configured to rotate about the central longitudinal axis 510 relative to the pile outer perimeter surface 504. As the pile 500 is rammed into the ground surface, the pile blades 508A, 508B can be configured to rotate about the central longitudinal axis 510 while the pile body 502 is vertically rammed into the ground surface in a direction on, or parallel to, the central longitudinal axis 510. In so ramming the pile 500, the pile blades 508A, 508B can engage with the soil and act to provide both vertical load resistance and lateral load resistance to help keep the pile 500 embedded within the ground surface. For instance, the portion of the pile blades 508A, 508B that extend, at a skewed orientation relative to the central longitudinal axis 510, the distance 520 longitudinally along the pile outer perimeter surface 504 can provide lateral load resistance and the portion of the pile blades 508A, 508B that extend, at a skewed orientation relative to the central longitudinal axis 510, the distance 521 radially along the pile outer perimeter surface 504 can provide vertical load resistance.

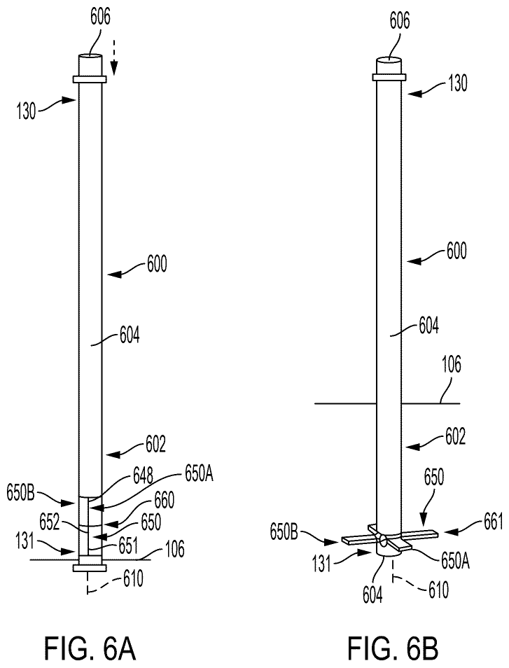

FIGS. 6A and 6B illustrate another embodiment of a rammable solar tracker foundation pile 600 that includes one or more stabilizing fingers 650. As noted, the pile 600 can be used as the first and/or second pile in the sequence disclosed at FIG. 2 (e.g., pile 600 can be the first pile 115 and the second pile 116 in the sequence at FIG. 2). FIG. 6A shows a side elevational view of this rammable solar tracker foundation pile 600 with the pile stabilizing fingers 650 at a stowed configuration, and FIG. 6B is the same side elevational view of this rammable solar tracker foundation pile 600 with pile 600 rammed into ground surface 106 and pile stabilizing fingers 650 at a deployed configuration.

The pile 600 can include a pile body 602. The pile body 602 can include a pile outer perimeter surface 604 that encloses a hollow interior 606 at the pile body 602. The pile body 602 can further include proximal pile end portion 130 and distal pile end portion 131.

The pile body 602 can further include one or more stabilizing fingers 650. For example, the pile body 602 can include at least two pile stabilizing fingers 650A, 650B at the pile body 602. Each of the at least two pile stabilizing fingers 650A, 650B can be configured, as a result of ramming the pile body 602 into ground surface 106, to move from a stowed configuration 660 to a deployed configuration 661. In the stowed configuration 660, the pile stabilizing fingers 650A, 650B can each be at the pile outer perimeter surface 604 and generally parallel to central longitudinal axis 610 of pile body 602. In the deployed configuration 661, the pile stabilizing fingers 650A, 650B can each extend out from the pile outer perimeter surface 604 at a skewed or perpendicular orientation relative to the central longitudinal axis 610 of the pile body 602.

The pile stabilizing fingers 650 can be located at the distal pile end portion 131. For example, the pile stabilizing fingers 650 can each be located at the distal pile end portion 131 outside of the hollow interior 606 at each of the stowed and deployed configurations 660, 661. In some such examples, in the stowed configuration 660, the pile stabilizing fingers 650 can overlay the pile body 602 and thus in the stowed configuration, such as shown at FIG. 6A, the pile stabilizing fingers 650 can form an outer perimeter surface at the distal pile end portion 131 in the stowed configuration. Yet in the deployed configuration 661, such as shown at FIG. 6B, the pile stabilizing fingers 650 can move off of the distal pile end portion 131 to reveal the pile outer perimeter surface 604 at distal pile end portion 131 at the pile body 602.

For the illustrated embodiment, to help configure the pile stabilizing fingers 650 to move from the stowed to deployed configuration when rammed into the ground surface 106, the illustrated embodiment of the pile 600 includes a slit 648, at pile body 602, that separates first pile stabilizing finger 650A from second pile stabilizing finger 650B. Likewise, the pile body 602 can include additional slits 648 separating additional stabilizing fingers 650. For example, the first pile stabilizing finger 650A can define a first longitudinal side 651, and the second pile stabilizing finger 650B can define a second longitudinal side 652. The slit 648 shown at FIG. 6A can separate the first longitudinal side 651 at the first pile stabilizing finger 650A from the second longitudinal side 652 at the second pile stabilizing finger 650B. The slit 648 can enable the stabilizing fingers 650A, 650B to move from the stowed configuration 660 to the deployed configuration 661 as a result of an applied vertical ramming force at the pile 600. Thus, as the pile body 602 in rammed vertically into the ground surface 106, the stabilizing fingers 650A, 650B can incrementally move from the stowed configuration 660 to the deployed configuration 661. Notably, this can configure the stabilizing fingers 650 to act as secure rivet-like connections with the soil when the pile 600 is rammed to be embedded within the ground.

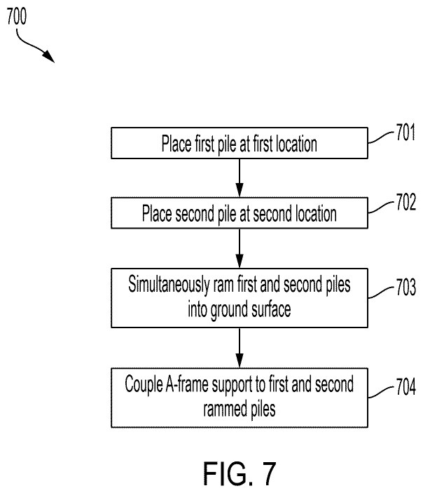

FIG. 7 is a flow diagram of an embodiment of a method 700 for installing a solar tracker A-frame foundation using rammed A-frame piles to support an A-frame support. For instance, the method 700 can be executed using any one or more features of the exemplary embodiments disclosed elsewhere herein, for instance, using any of the solar tracker embodiments disclosed herein, using any of the solar tracker A-frame foundation embodiments disclosed herein, and/or using any of the solar tracker rammable pile embodiments disclosed herein.

At step 701, the method 700 includes placing a first pile at a first location along a ground surface.

At step 702, the method 700 includes placing a second pile at a second location along the ground surface. The second location can be spaced apart from the first location where the first pile is placed at the ground surface. For instance, the first pile placed at step 701 and the second pile placed at step 702 can form a pair of piles that when embedded into the earth are configured as a pair to support an A-frame support that collectively form an A-frame foundation for a solar tracker, such as a single-axis solar tracker.

At step 703, the method 700 includes simultaneously ramming the first pile into the ground surface at the first location and ramming the second pile into the ground surface at the second location. For instance, simultaneously ramming the first pile into the ground surface at the first location and ramming the second pile into the ground surface at the second location can include vertically driving the first pile into the ground surface at the first location without rotatably driving the first pile into the ground surface at the first location and at a same time vertically driving the second pile into the ground surface at the second location without rotatably driving the second pile into the ground surface at the second location. Vertically driving the first pile into the ground surface at the first location without rotatably driving the first pile into the ground surface at the first location can include applying vertical ramming force along or parallel to a central longitudinal axis of the first pile without applying rotational torque about the central longitudinal axis of the first pile. Likewise, vertically driving the second pile into the ground surface at the second location without rotatably driving the second pile into the ground surface at the second location can include applying vertical ramming force along or parallel to a central longitudinal axis of the second pile without applying rotational torque about the central longitudinal axis of the second pile.

In some such embodiments, at step 703, simultaneously ramming the first pile into the ground surface at the first location and ramming the second pile into the ground surface at the second location can include using a single ramming hammer to ram each of the first pile into the ground surface at the first location and the second pile into the ground surface at the second location at the same time. For instance, prior to simultaneously ramming the first pile and the second pile into the ground surface at step 703, the method 700 can include a step of placing a ramming adapter at the first pile, at the second pile, and across the first pile and the second pile. Then, at step 703, using the single ramming hammer to ram each of the first pile into the ground surface at the first location and the second pile into the ground surface at the second location at the same time can include ramming the single ramming hammer into direct contact with the ramming adapter to simultaneously: (i) vertically drive the first pile into the ground surface at the first location without rotatably driving the first pile into the ground surface at the first location, and (ii) vertically drive the second pile into the ground surface at the second location without rotatably driving the second pile into the ground surface at the second location. Then, after so simultaneously ramming the first and second piles at step 703 using the ramming adapter and prior to coupling A-frame support legs to the rammed first and second piles at step 704, the method 700 can include a step of removing the ramming adapter from each of the first pile and the second pile.

At step 704, the method 700 includes, after simultaneously ramming the first and second piles into the ground surface, coupling a first leg of a solar tracker A-frame support to the first pile and coupling a second leg of the solar tracker A-frame support to the second pile. For instance, the coupled A-frame support legs at the rammed, earth embedded first and second piles can form a solar tracker A-frame foundation, for instance, for a single-axis solar tracker system.

The following is directed to additional embodiments of solar tracker foundation piles within the scope of the present disclosure. Any of the following embodiments of solar tracker foundation piles can be used in conjunction with any of the other embodiments disclosed elsewhere herein, for instance in the method 700 described above. Such following solar tracker foundation piles can be driven (e.g., rammed) into the ground and then coupled to a solar tracker support frame, such as an A-frame, to thereby support via the ground one or more solar tracker system components (e.g., torque tube).

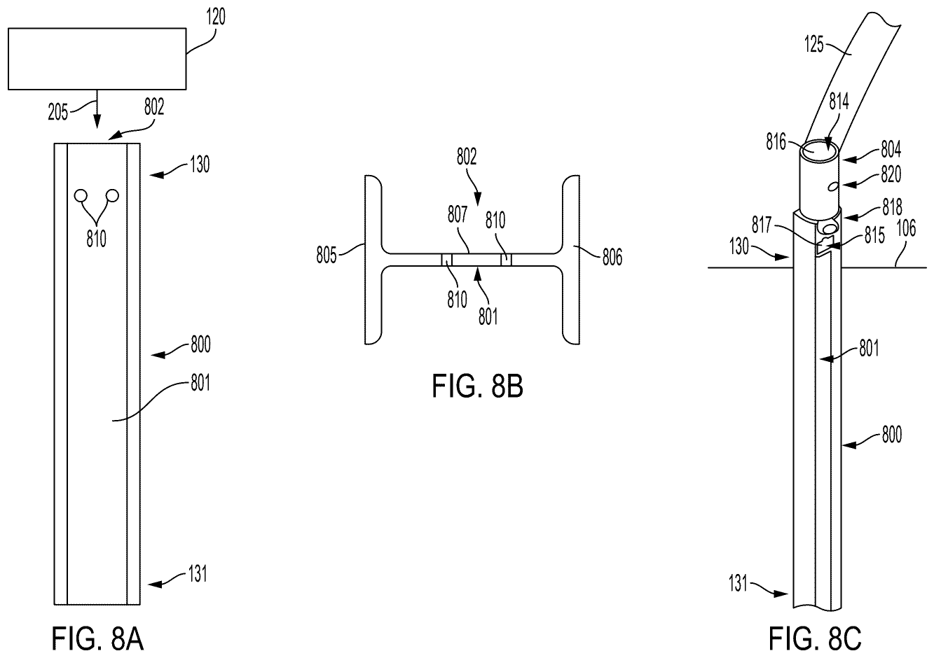

FIGS. 8A-8C illustrate another embodiment of a rammable solar tracker foundation pile 800 that includes an I-beam cross-section 802. FIG. 8A is a side elevational view of the I-beam rammable solar tracker foundation pile 800 being rammed into the ground surface 106, FIG. 8B is a plan view of the I-beam cross-section 802, and FIG. 8C is a perspective view showing a frame coupling adapter 804 coupled to the I-beam rammable solar tracker foundation pile 800 (e.g., after the pile 800 has been embedded in the ground). For some applications, the pile 800 can be used as the first and/or second pile in the sequence disclosed at FIG. 2 (e.g., pile 800 can be the first pile 115 and the second pile 116 in the sequence at FIG. 2).

The pile 800 can include a pile body 801. The pile body 801 can define the I-beam cross-section 802. As seen at the example shown at FIG. 8B, the I-beam cross-section 802 can include a first base portion 805, a second base portion 806, and a cross portion 807 that connects the first base portion 805 to the second base portion 806. The illustrated example shows the cross portion 807 interconnecting the first and second base portions 805, 806 at the midpoint along the length of each of the first and second base portions 805, 806. The illustrated embodiment of the pile 800 includes the I-beam cross-section 802 along all of the length of the pile body 801, though for other embodiments the I-beam cross-section may be present at less than all of the length of the pile body 801.

The pile body 801 can define pile proximal end portion 130 at one end portion of its length and define pile distal end portion 131 at an opposite end portion of its length. The pile proximal end portion 130 can be configured to be rammed, for instance, via the ramming hammer 120, while the pile distal end portion 131 can be configured to vertically drive into the ground surface when the pile 800 is rammed at the pile proximal end portion 130. Namely, the pile distal end portion 131 can be configured to penetrate, and be vertically driven into, ground surface 106 when rammed (e.g., when rammed at the opposite pile proximal end portion 130). The I-beam cross-section 802 defined by the pile 800 can provide useful advantages associated with improved soil engagement, improved structural stability, and/or increased lateral load bearing capacity via the I-beam cross-section 802 engagement with the soil when embedded in the ground 106, yet while also allowing for cost effective and quick pile 800 installation in the ground.

The pile body 801 can include one or more adapter fastening apertures 810. The illustrated embodiment includes two adapter fastening apertures 810. The adapter fastening apertures 810 can be, for instance, at the pile proximal end portion 130. For some applications, the pile 800 can be embedded in the ground 106 (e.g., rammed into the ground 106) such that the pile proximal end portion 130 having the one or more adapter fastening apertures 810 remains above the ground surface 106 and thus is exposed and accessible above the ground surface 106. The adapter fastening apertures 810 can be configured to couple to the frame coupling adapter 804. For example, the pile 800 can be first embedded in the ground 106, and then the frame coupling adapter 804 can be coupled to the one or more adapter fastening apertures 810 art the pile proximal end portion 130 that is exposed and accessible above the ground surface 106 after the pile 800 has been embedded in the ground (e.g., after the pile distal end portion 131 has been embedded in the ground 106).

FIG. 8C shows the frame coupling adapter 804 coupled to the pile 800. In particular, the frame coupling adapter 804 can be coupled to the one or more adapter fastening apertures 810 pile proximal end portion 130. For instance, the frame coupling adapter 804 can be coupled to the one or more adapter fastening apertures 810 pile proximal end portion 130 that is exposed above the ground surface 106 after the pile 800 has been embedded in the ground (e.g., after the pile distal end portion 131 has been embedded in the ground 106). The frame coupling adapter 804 can be configured to couple to a solar tracker support frame, such as a solar tracker A-frame foundation. FIG. 8C shows the frame coupling adapter 804 receiving a leg 125 of a solar tracker A-frame foundation.

The frame coupling adapter 804 can include an adapter proximal end portion 814 and an adapter distal end portion 815. The adapter proximal end portion 814 can define an opening 816 that is configured to receive at least a portion of a solar tracker support frame, such as leg 125 of a solar tracker A-frame foundation. The adapter distal end portion 815 can include one or more coupling flanges 817 for coupling to the pile 800. The one or more coupling flanges 817 can include one or more pile fastening apertures 818. For example, the adapter distal end portion 815 can include a first coupling flange 817 having one or more pile fastening apertures 818 for coupling to the one or more adapter fastening apertures 810 at a first side of the pile proximal end portion 130 at the pile 800 and include a second coupling flange 817 having one or more pile fastening apertures 818 for coupling to the one or more adapter fastening apertures 810 at a second, opposite side of the pile proximal end portion 130 at the pile 800. One or more fastening members (e.g., bolts) can be inserted between the interfacing one or more coupling flanges 817 and the cross portion 807 having the one or more pile fastening apertures 818 to couple the frame coupling adapter 804 to the pile 800 (e.g., to the cross portion 807 of the I-beam cross-section 802 at the proximal end portion 130 of the pile 800).

As also shown for the illustrated embodiment, the frame coupling adapter 804 can include one or more frame fastening apertures 820. When at least a portion of a solar tracker support frame, such as leg 125 of a solar tracker A-frame foundation, is received at the opening 816, one or more fastening members can be inserted through the one or more frame fastening apertures 820 at the frame coupling adapter and the received portion of the solar tracker support frame to couple the received portion of the solar tracker frame, at the opening 816, to the frame coupling adapter 804 and thus also then to the pile 800.

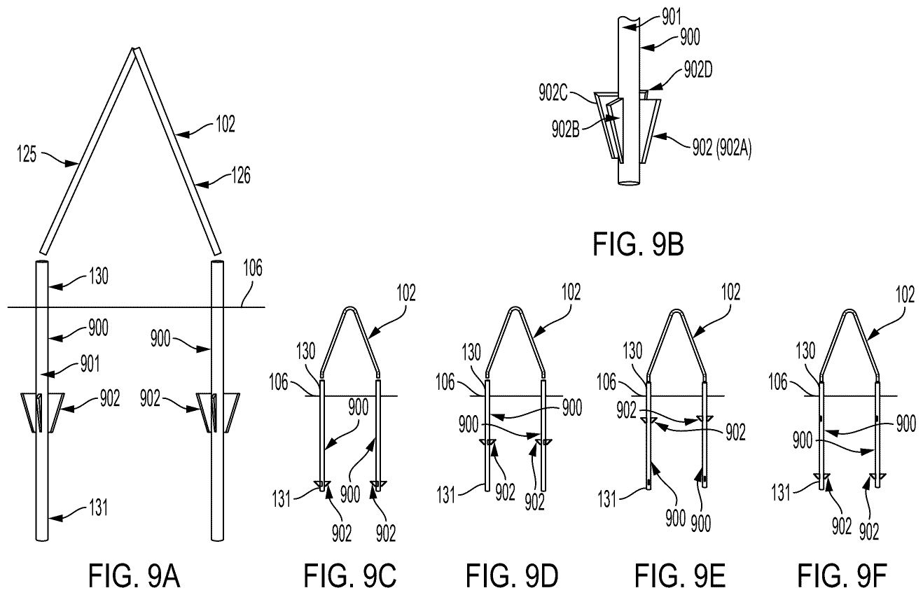

FIGS. 9A-9F illustrate another embodiment of a rammable solar tracker foundation pile 900 that includes cross blades 902. FIG. 9A is schematic diagram showing a pair of cross blade solar tracker foundation piles 900 embedded in the ground 106 and supporting an above ground A-frame 102 (first pile 900 support leg 125 and second pile 900 supporting second leg 126 of the A-frame 102). FIG. 9B is a perspective view of one exemplary embodiment of cross blades 902 at the solar tracker foundation pile 900. FIGS. 9C-9F illustrate elevational views of various embodiments of a pair of cross blade solar tracker foundation piles 900 embedded in the ground 106 and supporting the above ground A-frame 102. For some applications, the pile 900 can be used as the first and/or second pile in the sequence disclosed at FIG. 2 (e.g., pile 900 can be the first pile 115 and the second pile 116 in the sequence at FIG. 2). While the pile 900 is capable of being rammed to embed it in the ground 106, in other applications the pile 900 can be driven into the ground 106 via other means (e.g., via rotary driving of the pile 900).

The pile 900 can include a pile body 901. The pile body 901 can define pile proximal end portion 130 at one end portion of its length and define pile distal end portion 131 at an opposite end portion of its length. The pile proximal end portion 130 can be configured to be rammed, for instance, via the ramming hammer 120, while the pile distal end portion 131 can be configured to vertically drive into the ground surface when the pile 900 is rammed at the pile proximal end portion 130. Namely, the pile distal end portion 131 can be configured to penetrate, and be vertically driven into, ground surface 106 when rammed (e.g., when rammed at the opposite pile proximal end portion 130). The inclusion of the cross blades 902 at the pile body 901 can provide useful advantages associated with improved soil engagement at the cross blades 902 thereby improving structural stability of the solar tracker foundation associated with the pile 900, yet while also facilitating cost effective and quick pile 900 installation in the ground 106.

The pile body 901 can include one or more cross blades 902. The illustrated embodiment of the pile 900 includes four cross blades 902A, 902B, 902C, 902D at the pile body 901. Cross blade 902A and cross blade 902C can be aligned across the pile body 901, and cross blade 902B and cross blade 902D can be aligned across the pile body 901. Thus, the cross blades 902 for the illustrated embodiment can define two pairs of cross blades-a first pair of cross blades 902A and 902C positioned opposite one another about a perimeter of the pile body 901 and a second pair of cross blades 902B and 902D positioned opposite one another about the perimeter of the pile body 901. In some examples, the cross blades 902A, 902B, 902C, 902D can be generally equally spaced a quarter increments from one another about the perimeter of the pile body 901. The inclusion of cross blades 902 in such pairs aligned across opposite sides of the pile body 901 can help to increase the lateral load bearing capacity of the pile 900.

As shown here for the illustrated embodiment, the cross blades 902 can taper in width. For example, the cross blades 902 can taper in width progressing in a direction toward the pile distal end portion 131 such that the cross blade 902 is wider nearer the pile proximal end portion 130 and narrower nearer the pile distal end portion 131. Such taper can, for some examples, be a continuous taper of the width of the cross blade 902 along an entire length of the cross blade 902.

FIGS. 9C-9F illustrate different locations for the one or more cross blades 902 along the length of the pile 900. FIG. 9C shows first pair of cross blades 902A, 902C and second pair of cross blades 902B, 902D each at or adjacent to the pile distal end portion 131 and embedded in the ground 106. FIG. 9D shows first pair of cross blades 902A, 902C and second pair of cross blades 902B, 902D, embedded in the ground 106, and each at generally an intermediate portion of the pile body 901 that is between the pile distal end portion 131 and the pile proximal end portion 130. FIG. 9E shows a pair of cross blades 902A, 902C adjacent to the pile proximal end portion 130 but still embedded in the ground 106. FIG. 9F shows one pair of cross blades 902A, 902C at or adjacent to the pile distal end portion 131 and embedded in the ground 106.

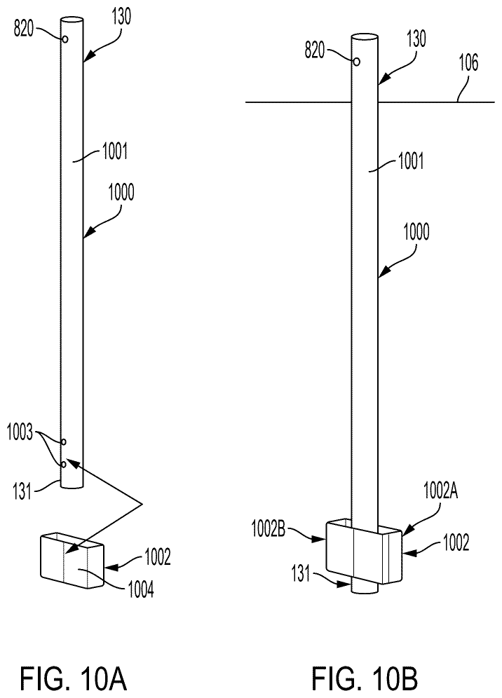

FIGS. 10A and 10B illustrate yet another embodiment of a rammable solar tracker foundation pile 1000 that includes a bolted cross blade 1002. FIG. 10A is an exploded, assembly view of this rammable solar tracker foundation pile 1000, and FIG. 10B is an elevational view of the assembled rammable solar tracker foundation pile 1000 with bolted cross blade 1002. For some applications, the pile 1000 can be used as the first and/or second pile in the sequence disclosed at FIG. 2 (e.g., pile 1000 can be the first pile 115 and the second pile 116 in the sequence at FIG. 2). While the pile 1000 is capable of being rammed to embed it in the ground 106, in other applications the pile 1000 can be driven into the ground 106 via other means (e.g., via rotary driving of the pile 1000). The cross blade 1002 can be similar to the cross blade 902 disclosed previously herein except that the cross blade 1002 can define a type of integrated pair of cross blades 902 as a single component cross blade 1002.

Referring to FIG. 10A, the cross blade 1002 can be coupled to pile body 1001 of pile 1000. The pile body 1001 can include one or more cross blade fastening apertures 1003 that are configured to couple to complementary pile fastening apertures 1004 at the integral cross blade 1002. As such, one or more fastening members (e.g., one or more bolts) can be inserted through the aligned cross blade fastening apertures 1003, at the pile body 1001, and complementary pile fastening apertures 1004, at the integral cross blade 1002, to thereby couple the integral cross blade 1002 to the pile body 1001. The pile body 1001 can be configured to couple to the cross blade 1002 at the pile distal end portion 131. For such an embodiment, the one or more cross blade fastening apertures 1003 can be included at the pile distal end portion 131 of the pile body 1001. Referring to FIG. 10B, when the cross blade 1002 is coupled to the pile body 1001, a first blade portion 1002A at the integral cross blade 1002 can project out from the pile body 1001 at a first side of the pile body 1001 and a second blade portion 1002B at the integral cross blade 1002 can project out from the pile body 1001 at a second, opposite side of the pile body 1001 such that the first and second blade portions 1002A, 1002B are aligned with one another at opposite sides of the perimeter of the pile body 1001. The pile 1000 can be embedded into the ground 106 and the cross blade 1002 can help to increase the lateral load bearing capacity associated with the pile 1000.

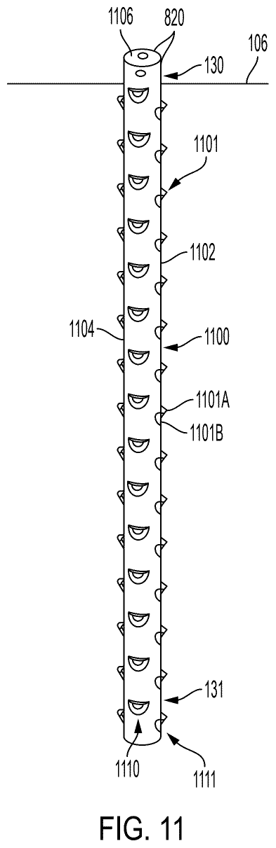

FIG. 11 is an elevational view of another embodiment of a rammable solar tracker foundation pile 1100 that includes a plurality of embedment projections 1101. For some applications, the pile 1100 can be used as the first and/or second pile in the sequence disclosed at FIG. 2 (e.g., pile 1100 can be the first pile 115 and the second pile 116 in the sequence at FIG. 2). While the pile 1100 is capable of being rammed to embed it in the ground 106, in other applications the pile 1100 can be driven into the ground 106 via other means (e.g., via rotary driving of the pile 1100).

The pile 1100 includes a pile body 1102. The pile body 1102 includes a pile outer perimeter surface 1104 that encloses a hollow interior 1106 at the pile body 1102. The pile body 1102 illustrated here can have a closed pile outer perimeter surface 1104 that fully encloses the hollow interior 1106. For example, as shown for the embodiment illustrated here at FIG. 11, the pile body 1102 can have a cylindrical cross-sectional geometry that defines a closed pile outer perimeter surface 1104 that fully encloses the hollow interior 1106. In other embodiments within the scope of this disclosure, the pile body 1102 can have other cross-sectional geometries, for instance polygonal cross-sectional geometries, that define closed pile outer perimeter surface 1104 that fully encloses hollow interior 1106. Pile body 1102 having a closed pile outer perimeter surface 1104 that fully encloses the hollow interior 1106 can be useful in leveraging the increased load-bearing capacity and structural integrity of a pile body closed outer perimeter surface when embedded within the ground surface.

The pile body 1102 of the pile 1100 includes a plurality of embedment projections 1101. The embedment projections 1101 can be configured to increase vertical force resistance at the pile body 1102 to thereby increase the structural robustness of the solar tracker foundation associated with the pile 1100. Each of the embedment projections 1101 can project outward from the pile body 1102. For example, the plurality of embedment projections 1101 can define an outermost surface of the outer perimeter of the pile body 1102. For the illustrated embodiment, each of embedment projections 1101 can have a proximal end 1101A and a distal end 1101B. The proximal end 1101A of each embedment projection 1101 can be closer to the pile proximal end portion 130 than the distal end 1101B of each embedment projection 1101, and the distal end 1101B of each embedment projection 1101 can be closer to the pile distal end portion 131 than the proximal end 1101A of each embedment projection 1101. The proximal end 1101A of each embedment projection 1101 can project out radially further from the pile body 1102 than the distal end 1101B of each embedment projection 1101. As one further such example shown for the illustrated embodiment of the pile 1100 here at FIG. 11, the extent of the projection of each embedment projection 1101 outward from the pile body 1102 can taper moving in a direction toward the pile distal end portion 131. Namely, the proximal end 1101A of each embedment projection 1101 can extend out further than the distal end 1101B of each embedment projection 1101, and the magnitude of this extend of each embedment projection 1101 can decrease (E.g., continuously decrease) moving from the proximal end 1101A toward the distal end 1101B of each embedment projection 1101 in a direction toward the pile distal end portion 131. Such configuration of the projection of the embedment projections 1101 can help to case embedment of the pile 1000 into the ground 106 while also providing vertical pullout force resistance via the increasing extent of the projection of the embedment projections 1101 moving from the distal end 1101B to the proximal end 1101A of each embedment projection 1101 toward the pile proximal end portion 130.

For some embodiments, the embedment projections 1101 can be arranged at the pile body 1102 in a predetermined arrangement relative to one another. As one example shown for the illustrated embodiment of the pile 1100, the embedment projections 1101 can be arranged at the pile body 1102 in one or more rows. As shown here, the pile body 1102 can include a first vertical row 1110 of longitudinally aligned embedment projections 1101 and a second, spaced apart vertical row 1111 of longitudinally aligned embedment projections 1101. For other embodiments, the pile body 1102 can have one or more horizontal rows of radially aligned embedment projections 1101 with such one or more horizontal rows spaced apart along a length of the pile body 1102. Though other embodiments of the pile body 1102 having other relative embedment projection alignments can be used as well as randomized locations of the embedment projections 1101 along the pile body 1102.

The pile 1000 can be manufactured to include the embedment projections 1101 at the pile body 1102 in a variety of manners. As one example, a cylindrical steel pipe can be provided, and this cylindrical steel pipe can be stamped or otherwise structurally modified to define the embedment projections 1101 at the pile body 1102.

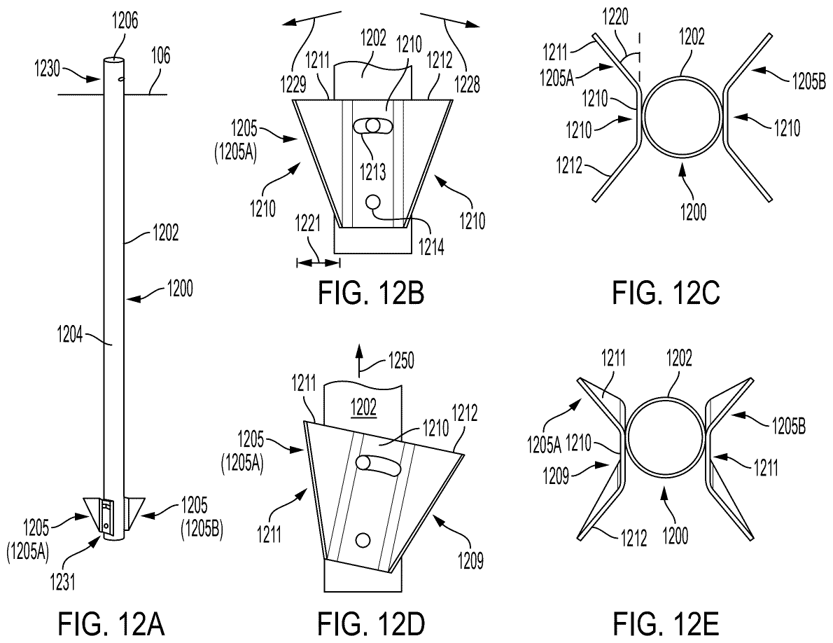

FIGS. 12A-12E illustrate another embodiment of a rammable solar tracker foundation pile 1200 that includes at least one rotatable bearing flange 1205. FIG. 12A is a perspective view of this rammable solar tracker foundation pile 1200. FIGS. 12B and 12C show rotatable bearing flanges 1205 of the rammable solar tracker foundation pile 1200 each at a flange installation orientation 1210, with FIG. 12B showing a side elevational view and FIG. 12C showing a top plan view. FIGS. 12D and 12E show rotatable bearing flanges 1205 of the rammable solar tracker foundation pile 1200 each at a flange pull out resistance orientation 1209. For some applications, the pile 1200 can be used as the first and/or second pile in the sequence disclosed at FIG. 2 (e.g., pile 1200 can be the first pile 115 and the second pile 116 in the sequence at FIG. 2). While the pile 1200 is capable of being rammed to embed it in the ground 106, in other applications the pile 1200 can be driven into the ground 106 via other means.

The pile 1200 can include a pile body 1202. The pile body 1202 can include a pile outer perimeter surface 1204 that encloses a hollow interior 1206 at the pile body 1202. The pile body 1202 can further include proximal pile end portion 1230 and distal pile end portion 1231. When installing the pile 1200 to embed it at least partially within the ground, distal pile end portion 1231 can be rammed or otherwise driven below ground surface 106 while at least a portion of the proximal pile end portion 1230 can be above the ground surface 106 after the pile 1200 has been embedded within the ground such that, for instance, a frame component (e.g., a frame leg) can be coupled to the proximal pile end portion 1230 above the ground surface 106. For example, as shown for the embodiment illustrated here at FIGS. 12A, the pile body 1202 can have a cylindrical cross-sectional geometry that defines a closed pile outer perimeter surface 1204 that fully encloses the hollow interior 1206. In other embodiments within the scope of this disclosure, the pile body 1202 can have other cross-sectional geometries, for instance polygonal cross-sectional geometries, that define closed pile outer perimeter surface 1204 that fully encloses hollow interior 1206. Pile body 1202 having a closed pile outer perimeter surface 1204 that fully encloses the hollow interior 1206 can be useful in leveraging the increased load-bearing capacity and structural integrity of a pile body closed outer perimeter surface when embedded within the ground surface.

The pile body 1202 can include one or more rotatable bearing flanges 1205. The illustrated example shows the pile body 1202 including two such rotatable bearing flanges 1205—first rotatable bearing flange 1205A and second rotatable bearing flange 1205B. The rotatable bearing flange(s) 1205 can be located, for instance, at the distal pile end portion 1231.

Each rotatable bearing flange 1205 can include a bearing flange base 1210, a first bearing flange wing 1211, and a second bearing flange wing 1212. The bearing flange base 1210 can be rotatably coupled to the pile body 1202 such that the rotatable bearing flange 1205 can rotate relative to the pile body 1202. For instance, as illustrated here, the bearing flange base 1210 can include an elongated coupling slot 1213 and a pivot coupling slot 1214, where the elongated coupling slot 1213 can be configured to receive a fastening member (e.g., a first pin) that can move along the elongated coupling slot 1213 while the pivot coupling slot 1214 can be configured to receive a fastening member (e.g., a second pin) that provides a pivot point thereat for about which the rotatable bearing flange 1205 can rotate relative to the pile body 1202, such as in each of opposite rotational directions 1228, 1229. The first bearing flange wing 1211 can project out from a first side of the bearing flange base 1210, and the second bearing flange wing 1212 can project out from a second, opposite side of the bearing flange base 1210. For example, the first flange wing 1211 and/or the second flange wing 1212 can project out from the first side of the bearing flange base 1210 at an angle 1220 ranging from ten to eighty degrees, such as from thirty to sixty degrees. Each of the first and second bearing flange wings 1211, 1212 can taper (e.g., continuously taper) in width 1221 in a direction moving toward the distal pile end portion 1231 such that the width 1221 of each of the first and second bearing flange wings 1211, 1212 can be greatest at a top portion of each wing 1211, 1212 closest to the proximal pile end portion 1230 and can be least at an opposite bottom portion of each wing 1211, 1212 closest to the distal pile end portion 1231. For example, each

As noted, each rotatable bearing flange 1205 can be rotatable coupled to the pile body 1202 such that each rotatable bearing flange 1205 can rotate relative to the pile body 1202. For example, as shown at the example at FIGS. 12B and 12C, when the pile 1200 is being embedded within the ground (e.g., rammed into the ground), the one or more rotatable bearing flanges 1205 can be at the flange installation orientation 1210, an example of which is illustrated at FIGS. 12B and 12C. For instance, the flange installation orientation 1210 can include the first wing 1211 and the second wing 1212 at generally a common elevation relative to the pile body 1202 such that first wing 1211 and second wing 1212 each lie in a common plane that can be generally parallel to the ground surface 106. Then, once the pile 1200 has been embedded into the ground as desired, when a force 1250 is applied to the pile body 1202, the one or more rotatable bearing flanges 1205 can move from the flange installation orientation 1210 to the flange pull out resistance orientation 1209. For instance, the flange pull out resistance orientation 1209 can include the first wing 1211 and the second wing 1212 at different elevations to one another relative to the pile body 1202. The example shown at FIGS. 12D and 12E shows each of the first and second rotatable bearing flanges 1205A, 1205 rotated in the direction 1228 from the flange installation orientation 1210 such that the flange pull out resistance orientation 1209 has the first wing 1211 at a different (e.g., greater) elevation relative to the pile body 1202 than the second wing 1212 such that first wing 1211 and second wing 1212 each lie in a common plane that can be skewed relative to the ground surface 106. At the flange pull out resistance orientation 1209, one of the wings 1211, 1212—at the example shown at FIGS. 12D and 12E the wing 1212—can be extended out from the pile body 1202 a greater extent than at the flange installation orientation 1210.

As noted, the one or more rotatable bearing flanges 1205 can move from the flange installation orientation 1210 to the flange pull out resistance orientation 1209 when force 1250 is applied at the pile 1200. As one example, force 1250 can be a pile pullout force applied in a direction away from the ground surface 106. Accordingly, for this example, when a pile pullout force is applied in the direction away from the ground surface 106, the one or more rotatable bearing flanges 1205 can rotate relative to the pile body 1202 from the flange installation orientation 1210 to the flange pull out resistance orientation 1209. Moving the one or more rotatable bearing flanges 1205 from the flange installation orientation 1210 to the flange pull out resistance orientation 1209, as a result of application of force 1250 at pile body 1202, can act to increase end bearing capacity associated with the pile body 1202 to help resist the force 1250.

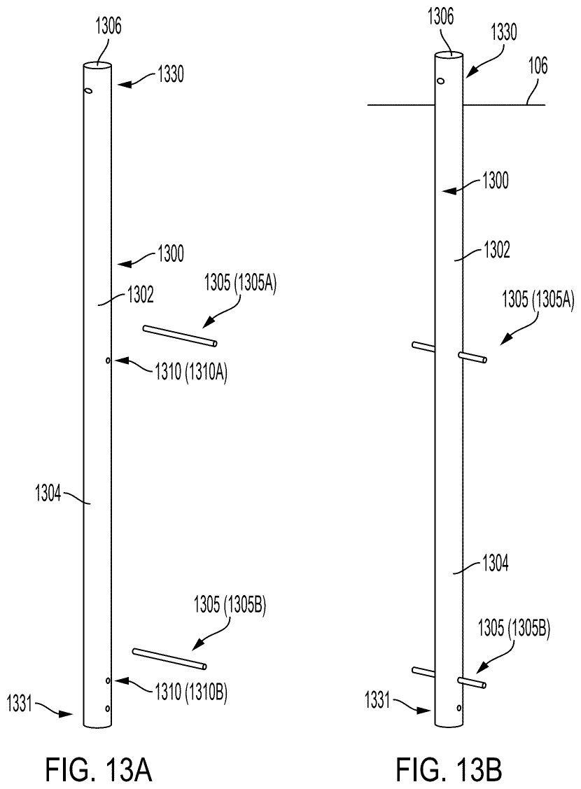

FIGS. 13A and 13B illustrate yet another embodiment of a rammable solar tracker foundation pile 1300 that includes at least one bearing pin 1305. FIG. 13A is an exploded, assembly view of this rammable solar tracker foundation pile 1300, and FIG. 13B is a perspective view of the assembled rammable solar tracker foundation pile 1300 with at least one bearing pin 1305. For some applications, the pile 1300 can be used as the first and/or second pile in the sequence disclosed at FIG. 2 (e.g., pile 1300 can be the first pile 115 and the second pile 116 in the sequence at FIG. 2). While the pile 1300 is capable of being rammed to embed it in the ground 106, in other applications the pile 1300 can be driven into the ground 106 via other means.

The pile 1300 can include a pile body 1302. The pile body 1302 can include a pile outer perimeter surface 1304 that encloses a hollow interior 1306 at the pile body 1302. The pile body 1302 can further include proximal pile end portion 1330 and distal pile end portion 1331. When installing the pile 1300 to embed it at least partially within the ground, distal pile end portion 1331 can be rammed or otherwise driven below ground surface 106 while at least a portion of the proximal pile end portion 1330 can be above the ground surface 106 after the pile 1300 has been embedded within the ground such that, for instance, a frame component (e.g., a frame leg) can be coupled to the proximal pile end portion 1330 above the ground surface 106. For example, as shown for the embodiment illustrated here, the pile body 1302 can have a cylindrical cross-sectional geometry that defines a generally closed pile outer perimeter surface 1304 that fully encloses the hollow interior 1206 (e.g., except at location(s) of bearing pin aperture(s) 1310 at the pile body 1302). In other embodiments within the scope of this disclosure, the pile body 1302 can have other cross-sectional geometries, for instance polygonal cross-sectional geometries, that define generally closed pile outer perimeter surface 1304 that encloses hollow interior 1306. Pile body 1302 having a closed pile outer perimeter surface 1304 that fully encloses the hollow interior 1306 can be useful in leveraging the increased load-bearing capacity and structural integrity of a pile body closed outer perimeter surface when embedded within the ground surface.

The pile body 1302 can include one or more bearing pins 1305 and one or more bearing pin apertures 1310. The illustrated embodiment shows the pile body 1302 as including first bearing pin 1305A and second bearing pin 1305B and as including first bearing pin aperture 1310A and second bearing pin aperture 1310B. The first bearing pin 1305A can be received at the pile body 1302 at the first bearing pin aperture 1310A, and the second bearing pin 1305B can be received at the pile body 1302 at the second bearing pin aperture 1310B. For instance, the bearing pin 1305 can be welded or otherwise coupled (e.g., fastened using a fastening member, such as a threaded fastening member) to the pile body 1302 at the respective bearing pin aperture 1310. In other instances, the one or more bearing pins 1305 can be manufactured as integral with the pile body 1302 at the illustrated locations of the one or more bearing pin apertures 1310. The illustrated example shows the first and second bearing pins 1305A, 1305B extending out from the pile body 1302 generally perpendicular to the pile body 1302, and the illustrated example shows the first and second bearing pins 1305A, 1305B extending out from the pile body 1302 in a same direction at the same opposite sides at the pile body 1302. Other examples can include the first and second bearing pins 1305A, 1305B extending out from the pile body 1302 at a skewed angle relative to the pile body 1302 and/or with the first and second bearing pins 1305A, 1305B extending out from the pile body 1302 in different directions (e.g., spaced approximately ninety degrees from one another around the outer perimeter surface 1304). The inclusion of the one or more bearing pins 1305 at the pile body 1302 can act to increase a bearing capacity associated with the pile body 1302 to help resist pullout force and/or laterally applied loads at the pile body 1302.

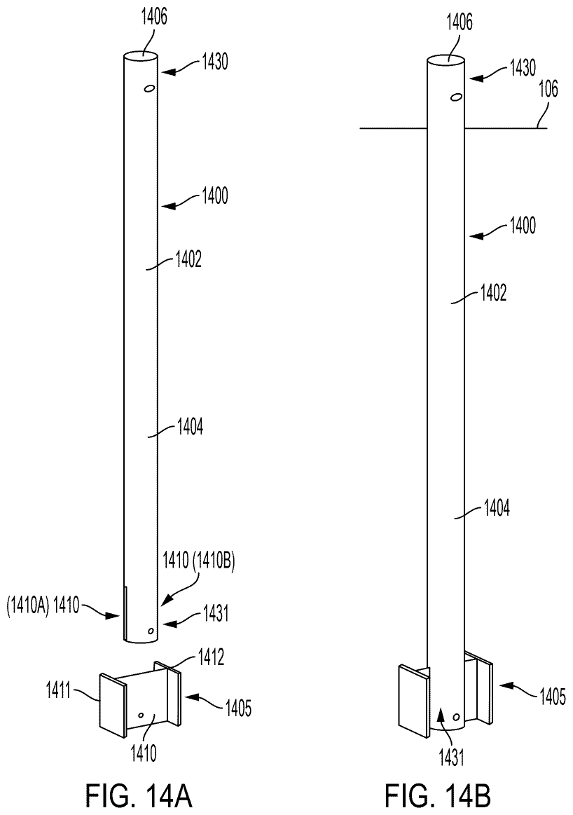

FIGS. 14A and 14B illustrate another embodiment of a rammable solar tracker foundation pile 1400 that includes a bearing beam adapter 1405. FIG. 14A is an exploded, assembly view of this rammable solar tracker foundation pile 1400, and FIG. 14B is a perspective view of the assembled rammable solar tracker foundation pile 1400 with bearing beam adapter 1405. For some applications, the pile 1400 can be used as the first and/or second pile in the sequence disclosed at FIG. 2 (e.g., pile 1400 can be the first pile 115 and the second pile 116 in the sequence at FIG. 2). While the pile 1400 is capable of being rammed to embed it in the ground 106, in other applications the pile 1400 can be driven into the ground 106 via other means.

The pile 1400 can include a pile body 1402. The pile body 1402 can include a pile outer perimeter surface 1404 that encloses a hollow interior 1406 at the pile body 1402. The pile body 1402 can further include proximal pile end portion 1430 and distal pile end portion 1431. When installing the pile 1400 to embed it at least partially within the ground, distal pile end portion 1431 can be rammed or otherwise driven below ground surface 106 while at least a portion of the proximal pile end portion 1430 can be above the ground surface 106 after the pile 1400 has been embedded within the ground such that, for instance, a frame component (e.g., a frame leg) can be coupled to the proximal pile end portion 1430 above the ground surface 106. For example, as shown for the embodiment illustrated here, the pile body 1402 can have a cylindrical cross-sectional geometry that defines a generally closed pile outer perimeter surface 1404 that fully encloses the hollow interior 1406 (e.g., except at location(s) of adapter coupling slot(s) 1410 at the pile body 1402). In other embodiments within the scope of this disclosure, the pile body 1402 can have other cross-sectional geometries, for instance polygonal cross-sectional geometries, that define generally closed pile outer perimeter surface 1404 that encloses hollow interior 1406. Pile body 1402 having a closed pile outer perimeter surface 1404 that fully encloses the hollow interior 1406 can be useful in leveraging the increased load-bearing capacity and structural integrity of a pile body closed outer perimeter surface when embedded within the ground surface.

The pile body 1402 can include one or more bearing beam adapters 1405 and one or more adapter coupling slot(s) 1410. The illustrated embodiment shows the pile body 1402 as including one bearing beam adapter 1405 at the distal pile end portion 1431 and two adapter coupling slots—first adapter coupling slot 1410A and second adapter coupling slot 1410B—also at the distal pile end portion 1431. The bearing beam adapter 1405 can be received at the pile body 1402 at the first and second adapter coupling slots 1410A, 1410B. For instance, the bearing beam adapter 1405 can include an I beam or a W beam cross-sectional geometry, and this I beam or W beam cross-sectional geometry can be coupled to the pile body 1402 at the distal pile end portion 1431 via the first and second adapter coupling slots 1410A, 1410B. For instance, the bearing beam adapter 1405 can be welded or otherwise coupled (e.g., fastened using a fastening member, such as a threaded fastening member, or bolt) to the pile body 1402 at the one or more adapter coupling slot(s) 1410. In other instances, the bearing beam adapter 1405 can be manufactured as integral with the pile body 1402 at the illustrated locations of the one or more adapter coupling slot(s) 1410. The inclusion of the bearing beam adapter 1405 at the pile body 1402 can act to increase a bearing capacity associated with the pile body 1402 to help resist pullout force and/or to help resist downward, in a direction toward the ground surface 106, applied loads at the pile body 1402.

For example, the bearing beam adapter 1405 can include central longitudinal flange portion 1410, first end radial flange portion 1411 extending out from one side of the central longitudinal flange portion 1401, and second end radial flange portion 1412 extending out from another, opposite side of the central longitudinal flange portion 1401. Each of the first and second end radial flange portions 1411, 1412 can be generally perpendicular to the central longitudinal flange portion 1401, and the first and second end radial flange portions 1411, 1412 can extend out from the central longitudinal flange portion 1401 at a parallel orientation relative to one another. For such example, the central longitudinal flange portion 1412 can be received at each of the first and second adapter coupling slots 1410A, 1410B at the pile body 1402 such that the first end radial flange portion 1411 projects out from a first side of the pile body 1402 (e.g., first end radial flange portion 1411 lies in a plane parallel to the central longitudinal axis of the pile body 1402) and second end radial flange portion 1412 projects out from a second, opposite side of the pile body 1402 (e.g., second end radial flange portion 1412 lies in a plane parallel to the central longitudinal axis of the pile body 1402 and parallel to the plane within which the first end radial flange portion 1412 lies).

Various examples have been described. These and other examples are within the scope of the following claims.

What is claimed is:

1. A method for installing a solar tracker A-frame foundation, the method comprising the steps of:
placing a first pile at a first location along a ground surface;
placing a second pile at a second location along the ground surface, the second location spaced apart from the first location;
simultaneously ramming the first pile into the ground surface at the first location and ramming the second pile into the ground surface at the second location; and
after simultaneously ramming the first and second piles into the ground surface, coupling a first leg of a solar tracker A-frame support to the first pile and coupling a second leg of the solar tracker A-frame support to the second pile.

2. The method of claim 1, wherein simultaneously ramming the first pile into the ground surface at the first location and ramming the second pile into the ground surface at the second location comprises vertically driving the first pile into the ground surface at the first location without rotatably driving the first pile into the ground surface at the first location and at a same time vertically driving the second pile into the ground surface at the second location without rotatably driving the second pile into the ground surface at the second location.

3. The method of claim 2,
wherein vertically driving the first pile into the ground surface at the first location without rotatably driving the first pile into the ground surface at the first location comprises applying vertical ramming force along or parallel to a central longitudinal axis of the first pile without applying rotational torque about the central longitudinal axis of the first pile, and
wherein vertically driving the second pile into the ground surface at the second location without rotatably driving the second pile into the ground surface at the second location comprises applying vertical ramming force along or parallel to a central longitudinal axis of the second pile without applying rotational torque about the central longitudinal axis of the second pile.

4. The method of claim 2, wherein simultaneously ramming the first pile into the ground surface at the first location and ramming the second pile into the ground surface at the second location comprises using a single ramming hammer to ram each of the first pile into the ground surface at the first location and the second pile into the ground surface at the second location at the same time.

5. The method of claim 4, further comprising:
prior to simultaneously ramming the first pile and the second pile into the ground surface, placing a ramming adapter at the first pile, at the second pile, and across the first pile and the second pile.

6. The method of claim 5, wherein using the single ramming hammer to ram each of the first pile into the ground surface at the first location and the second pile into the ground surface at the second location at the same time comprises ramming the single ramming hammer into direct contact with the ramming adapter to simultaneously: (i) vertically drive the first pile into the ground surface at the first location without rotatably driving the first pile into the ground surface at the first location, and (ii) vertically drive the second pile into the ground surface at the second location without rotatably driving the second pile into the ground surface at the second location.

7. The method of claim 6, further comprising:
after using the single ramming hammer to ram each of the first pile into the ground surface at the first location and the second pile into the ground surface at the second location at the same time and prior to coupling the first leg of the solar tracker A-frame support to the first pile and the second leg of the solar tracker A-frame support to the second pile, removing the ramming adapter from each of the first pile and the second pile.

8. The method of claim 6,
wherein the ramming adapter includes a first adapter pile connector at a first side of the ramming adapter, a second adapter pile connector at a second, opposite side of the ramming adapter, and a hammer contact interface located at the ramming adapter between the first adapter pile connector and the second adapter pile connector,
wherein placing the ramming adapter at the first pile, at the second pile, and across the first pile and the second pile comprises placing the first adapter pile connector at the first pile and placing the second adapter pile connector at the second pile such that the hammer contact interface is between the first pile and the second pile, and
wherein using the single ramming hammer to ram each of the first pile into the ground surface at the first location and the second pile into the ground surface at the second location at the same time comprises ramming the single ramming hammer into direct contact with the hammer contact interface between the first pile and the second pile.

9. The method of claim 2,
wherein the first pile comprises a first pile body that includes a first pile outer perimeter surface that encloses a hollow interior at the first pile body, and
wherein the second pile comprises a second pile body that includes a second pile outer perimeter surface that encloses a hollow interior at the second pile body.

10. The method of claim 9,
wherein the first pile body further includes: (i) at least one first pile wing projecting outward from the first pile outer perimeter surface in a direction perpendicular to a central longitudinal axis of the first pile, and (ii) a pointed first pile distal end that is configured to vertically drive into the ground surface, and
wherein the second pile body further includes: (i) at least one second pile wing projecting outward from the second pile outer perimeter surface in a direction perpendicular to a central longitudinal axis of the second pile, and (ii) a pointed second pile distal end that is configured to vertically drive into the ground surface.

11. The method of claim 9,
wherein the first pile body includes two or more first pile blades, each of the two or more first pile blades: projecting outward from the first pile outer perimeter surface in a direction perpendicular to a central longitudinal axis of the first pile and extending, at a skewed orientation relative to the central longitudinal axis of the first pile, both a distance longitudinally along the first pile outer perimeter surface and a distance radially along the first pile outer perimeter surface, and
wherein the second pile body includes two or more second pile blades, each of the two or more second pile blades: projecting outward from the second pile outer perimeter surface in a direction perpendicular to a central longitudinal axis of the second pile and extending, at a skewed orientation relative to the central longitudinal axis of the second pile, both a distance longitudinally along the second pile outer perimeter surface and a distance radially along the second pile outer perimeter surface.

12. The method of claim 11,
wherein each of the two or more first pile blades is rotatably coupled to the first pile outer perimeter surface, and
wherein each of the two or more second pile blades is rotatably coupled to the second pile outer perimeter surface.

13. The method of claim 1,
wherein the first pile comprises a first pile body that includes a first pile outer perimeter surface that encloses a hollow interior at the first pile body, the first pile body having a proximal first pile end portion and a distal first pile end portion, the first pile further comprising a first pile ramming drive shaft that includes a proximal first pile ramming drive shaft end portion and a distal first pile ramming drive shaft end portion, the distal first pile ramming drive shaft end portion coupled to the distal first pile end portion, the proximal first pile ramming drive shaft end portion extending out from the proximal first pile end portion such that the proximal first pile ramming drive shaft end portion is exposed outside of the hollow interior at the first pile body, and
wherein the second pile comprises a second pile body that includes a second pile outer perimeter surface that encloses a hollow interior at the second pile body, the second pile body having a proximal second pile end portion and a distal second pile end portion, the second pile further comprising a second pile ramming drive shaft that includes a proximal second pile ramming drive shaft end portion and a distal second pile ramming drive shaft end portion, the distal second pile ramming drive shaft end portion coupled to the distal second pile end portion, the proximal second pile ramming drive shaft end portion extending out from the proximal second pile end portion such that the proximal second pile ramming drive shaft end portion is exposed outside of the hollow interior at the second pile body.

14. The method of claim 13, wherein simultaneously ramming the first pile into the ground surface at the first location and ramming the second pile into the ground surface at the second location comprises simultaneously ramming the first pile at the exposed proximal first pile ramming drive shaft end portion and ramming the second pile at the exposed proximal second pile ramming drive shaft end portion.

15. The method of claim 14, further comprising:
after simultaneously ramming the first and second piles into the ground surface and prior to coupling the first leg of a solar tracker A-frame support to the first pile and coupling the second leg of the solar tracker A-frame support to the second pile, removing the exposed proximal first pile ramming drive shaft end portion from the first pile ramming drive shaft and removing the exposed proximal second pile ramming drive shaft end portion from the second pile ramming drive shaft.

16. The method of claim 1,
wherein the first pile comprises a first pile body that includes a first pile outer perimeter surface that encloses a hollow interior at the first pile body, the first pile body having a proximal first pile end portion and a distal first pile end portion, the first pile further comprising at least two first pile stabilizing fingers, wherein each of the at least two first pile stabilizing fingers is configured, as a result of ramming the first pile into the ground surface at the first location, to move from a stowed configuration at the first pile outer perimeter surface and generally parallel to a central longitudinal axis of the first pile to a deployed configuration extending out from the first pile outer perimeter surface at a skewed or perpendicular orientation relative to the central longitudinal axis of the first pile, and
wherein the second pile comprises a second pile body that includes a second pile outer perimeter surface that encloses a hollow interior at the second pile body, the second pile body having a proximal second pile end portion and a distal second pile end portion, the second pile further comprising at least two second pile stabilizing fingers, wherein each of the at least two second pile stabilizing fingers is configured, as a result of ramming the second pile into the ground surface at the second location, to move from a stowed configuration at the second pile outer perimeter surface and generally parallel to a central longitudinal axis of the second pile to a deployed configuration extending out from the second pile outer perimeter surface at a skewed or perpendicular orientation relative to the central longitudinal axis of the second pile.

17. A rammable solar tracker foundation pile comprising:
a pile body comprising a pile outer perimeter surface that encloses a hollow interior at the pile body, the pile body further comprising a proximal pile end portion and a distal pile end portion; and
a pile ramming drive shaft comprising a proximal pile ramming drive shaft end portion, a distal pile ramming drive shaft end portion, and a pile ramming drive shaft body extending between the proximal pile ramming drive shaft end portion and the distal pile ramming drive shaft end portion, the pile ramming drive shaft body located within the hollow interior of the pile body, the distal pile ramming drive shaft end portion coupled to the distal pile end portion, the proximal pile ramming drive shaft end portion uncoupled from the proximal pile end portion and extending out from the proximal pile end portion such that the proximal pile ramming drive shaft end portion is exposed outside of the hollow interior at the pile body.

18. The pile of claim 17,
wherein the pile ramming drive shaft body located within the hollow interior of the pile body is uncoupled from the pile body such that the pile ramming drive shaft is only coupled to the pile body where the distal pile ramming drive shaft end portion is coupled to the distal pile end portion, and
wherein the proximal pile ramming drive shaft end portion is deformable and configured to be removed from the pile ramming drive shaft after applying vertical ramming force at the proximal pile ramming drive shaft end portion.

19. A rammable solar tracker foundation pile comprising:
a pile body comprising a pile outer perimeter surface that encloses a hollow interior at the pile body, the pile body further comprising a proximal pile end portion and a distal pile end portion; and
at least two pile stabilizing fingers at the pile body, wherein each of the at least two pile stabilizing fingers is configured, as a result of ramming the pile body into a ground surface, to move from a stowed configuration at the pile outer perimeter surface and generally parallel to a central longitudinal axis of the pile body to a deployed configuration at which each of the at least two pile stabilizing fingers extends out from the pile outer perimeter surface at a skewed or perpendicular orientation relative to the central longitudinal axis of the pile body.

20. The pile of claim 19,
wherein each of the at least two pile stabilizing fingers is located at the distal pile end portion outside of the hollow interior at each of the stowed and deployed configurations, and
wherein the pile body comprises a slit separating a first longitudinal side of a first pile stabilizing finger of the at least two pile stabilizing fingers from a second longitudinal side of a second pile stabilizing finger of the at least two pile stabilizing fingers.
